(19) United States
(12) Patent Application Publication
(10) Pub. No.: US 2014/0122635 A1
(43) Pub. Date: May 1, 2014

(54) COMPUTER SYSTEM AND DATA MANAGEMENT METHOD

(71) Applicant: Hitachi, Ltd., Tokyo (JP)

(72) Inventors: Takashi Kaga, Odawara (JP); Hisao Honma, Odawara (JP)

(73) Assignee: HITACHI, LTD., Tokyo (JP)

(21) Appl. No.: 13/697,874

(22) PCT Filed: Oct. 31, 2012
(86) PCT No.: PCT/JP12/07000

§ 371 Date: Nov. 29, 2012

(51) Int. Cl. H04L 29/08

(52) U.S. Cl. CPC H04L 67/1097
USPC 709/213

(57) ABSTRACT

A computer system comprises a computer, a storage system comprising multiple storage apparatuses, and an edge storage apparatus. The edge storage apparatus stores identification information, which makes it possible to identify a volume, and first access information for accessing a logical storage apparatus, which stores volume data of the volume after associating the identification information with the first access information, a storage apparatus (A1) executes processing for transferring the volume data from a migration source to a logical storage apparatus, which is a migration destination, (A2) stores second access information for accessing the migration-destination logical storage apparatus in the storage apparatus, and (A3) sends the second access information, and the edge storage apparatus (B1) receives the second access information, and (B2) associates the second access information with the identification information enabling the identification of the volume, and stores the associated information in the storage apparatus.

### TECHNICAL FIELD

The present invention relates to technology for managing data in a logical storage space built in use of multiple storage apparatuses.

### BACKGROUND ART

Generally speaking, a method for virtualizing a logical storage area of multiple storage apparatuses in a storage system as a single storage resource is known. In a storage system such as this, a virtual logical storage space built using multiple storage apparatuses is referred to as a storage cloud.

Furthermore, in general, various types of physical storage apparatuses (a magnetic disk and flash memory) having a variety of attributes exists as storage apparatuses in a storage system. In the storage system, high-performance, high-reliability, high-cost storage apparatuses are used together with low-performance, low-reliability, low-cost storage apparatuses in accordance with the application. Specifically, frequently used data is stored in a physical storage area of a high-cost storage apparatus, and data archives and other such infrequently used data is stored in the physical storage area of a low-cost storage apparatus.

Hence, in the storage cloud, a logical storage space can be hierarchized using multiple logical storage apparatuses (LDEV) based on multiple storage apparatuses having various attributes. In the storage cloud, data based on an IO request from a host computer is stored in any of multiple LDEVs, and data is provided in accordance with the IO request from the host computer. In the storage cloud, in which the logical storage space is hierarchized, the data inside a LDEV comprising this logical storage space (hereinafter, referred to as volume data) is transferred (migrated) to another LDEV in accordance with how often it is accessed.

### CITATION LIST

### Patent Literature

### [PTL 1]

Application Laid-open No. 2008-40571

### SUMMARY OF INVENTION

### Technical Problem

In the above-mentioned prior-art storage system, when the volume data inside the storage cloud is migrated to a different LDEV so that the host computer can appropriately use the volume data in the storage cloud, the host computer must be aware of this migration and must change an access destination for the volume data appropriately. Also, in a case where the volume data is migrated to LDEVs across storage apparatuses, the host computer must suspend an application, which is using the volume data, to perform a setting change. Thus, the fact that work must be suspended during a volume data migration is inefficient, and the likelihood of a human error occurring during the host computer setting change is undeniable.

As a method for solving this problem, there is a method, which makes use of alternate path software and other such software functions installed in the host computer side (for example, refer to Patent Literature 1).

However, the problem is that a method, which uses software functions, is dependent on the OS running on the host computer.

### Solution to Problem

To solve the above problem, a computer system related to an aspect of the present invention comprises one or more computers; one or more storage systems comprising multiple storage apparatuses, which comprise one or more physical storage apparatuses and one or more logical storage apparatuses based on the one or more the physical storage apparatuses; and one or more edge storage apparatuses, which are coupled corresponding to one of the computers between the computer and the storage system.

A storage device of the edge storage apparatus stores identification information enabling the identification of a volume, which is provided to a computer and to which a storage area of a logical storage apparatus is allocated, and first access information for accessing the logical storage apparatus, which stores volume data of the volume in the storage system after associating the identification information with the first access information.

A control device of the storage apparatus (A1) executes processing for transferring the volume data from a migration-source logical storage apparatus, which is storing the volume data, to a migration-destination logical storage apparatus, (A2) stores second access information for accessing the migration-destination logical storage apparatus in a storage device of the storage apparatus, and (A3) sends the second access information to the edge storage apparatus.

A control device of the edge storage apparatus (B1) receives the second access information from the storage apparatus, and (B2) associates the second access information with the identification information, which makes it possible to identify the volume, and stores the associated information in the storage device of the edge storage apparatus.

### Advantageous Effects of Invention

According to the present invention, volume data used by a computer can be appropriately migrated without the need for some sort of action by the computer.

### BRIEF DESCRIPTION OF DRAWINGS

FIG. 1 shows the configuration of a computer system related to Example 1.

FIG. 2 shows the configuration of a storage apparatus.

FIG. 3 shows the configuration of an edge storage apparatus.

FIG. 4 shows a computer subsystem related to Example 1 at a certain point in time.

FIG. 5 is a block diagram of a memory of the edge storage apparatus.

FIG. 6A is an example of a LUN/GLDEV translation table of edge storage apparatus #1, and FIG. 6B is an example of a LUN/GLDEV translation table of edge storage apparatus #2.

FIG. 7A is an example of a GLDEV/internal path translation table of edge storage apparatus #1, and FIG. 7B is an example of a GLDEV/internal path translation table of edge storage apparatus #2.

FIG. 8 is a block diagram of a storage apparatus memory.

FIG. 9A is an example of a LLDEV/GLDEV translation table of storage apparatus #3, and FIG. 9B is an example of a LLDEV/GLDEV translation table of storage apparatus #4.

FIG. 10A is an example of a copy pair management table of storage apparatus #3, and FIG. 10B is an example of a copy pair management table of storage apparatus #4.

FIG. 11A is an example of a bitmap management table of storage apparatus #3, and FIG. 11B is an example of a bitmap management table of storage apparatus #4.

FIG. 12A is an example of a copy path management table of storage apparatus #3, and FIG. 12B is an example of a copy path management table of storage apparatus #4.

FIG. 13 is a flowchart of volume copy processing.

FIG. 14A shows the state of the copy pair management table of storage apparatus #3 at the time of an initial copy process, FIG. 14B shows the state of the bitmap management table 3 of storage apparatus #3 at the time of the initial copy process, and FIG. 14C shows the state of the copy pair management table of storage apparatus #3 at the time of the initial copy process.

FIG. 15 shows the state of the copy pair management table of storage apparatus #4 at the time of an initial copy process.

FIG. 16A shows the state of the bitmap management table of storage apparatus #3 at the end of the initial copy process, and FIG. 16B shows the state of the bitmap management table of storage apparatus #4 at the end of the initial copy process.

FIG. 17A shows the updated state of the copy pair management table of storage apparatus #3 at the time of a difference copy process, and FIG. 17B shows the updated state of the copy pair management table of storage apparatus #4 at the time of the difference copy process.

FIG. 18A shows the state of the LLDEV/GLDEV translation table of the storage apparatus #3 after a bitmap has been transferred, FIG. 18B shows the state of the copy pair management table of the storage apparatus #3 after a bitmap has been transferred, and FIG. 18C shows the state of the bitmap management table of the storage apparatus #3 after a bitmap has been transferred.

FIG. 19A shows the state of the LLDEV/GLDEV translation table of the storage apparatus #4 after a bitmap has been transferred, FIG. 19B shows the state of the copy pair management table of the storage apparatus #4 after a bitmap has been transferred, and FIG. 19C shows the state of the bitmap management table of the storage apparatus #4 after a copy pair has been transferred.

FIG. 20 is a diagram showing the state of a post-path-change computer subsystem in the storage apparatus.

FIG. 21 is a flowchart of path translation processing related to the example.

FIG. 22A shows the state of the LLDEV/GLDEV translation table of the storage apparatus #3 at a first point in time, FIG. 22B shows the state of the copy pair management table of the storage apparatus #3 at the first point in time, and FIG. 22C shows the state of the bitmap management table of the storage apparatus #3 at the first point in time.

FIG. 23 shows the state of the GLDEV/internal path translation table of the edge storage apparatus #1 at the first point in time.

FIG. 24A shows the state of the LLDEV/GLDEV translation table of the storage apparatus #4 at a second point in time, FIG. 24B shows the state of the copy pair management table of the storage apparatus #4 at the second point in time, and FIG. 24C shows the state of the bitmap management table of the storage apparatus #4 at the second point in time.

FIG. 25 is a diagram showing the state of the computer subsystem subsequent to the migration of a virtual machine of a host #1 to a host #2.

FIG. 26A shows the state of the LLDEV/GLDEV translation table of the storage apparatus #3 at a third point in time, and FIG. 26B shows the state of the copy pair management table of the storage apparatus #3 at the third point in time.

FIG. 27 shows the state of the GLDEV/internal path translation table of the edge storage #2 at the third point in time.

FIG. 28A shows the state of the copy pair management table of the storage apparatus #3 at the third point in time, and FIG. 28B shows the state of the copy path management table of the storage apparatus #3 at the third point in time.

FIG. 29A shows the state of the LLDEV/GLDEV translation table of the storage apparatus #4 at a fourth point in time, and FIG. 29B shows the state of the copy pair management table of the storage apparatus #4 at the fourth point in time.

FIG. 30 shows the state of the copy pair management table of the storage apparatus #4 at the fourth point in time.

### DESCRIPTION OF EMBODIMENTS

A number of examples of the present invention will be explained below.

In the following explanation, various information may be explained using the expression “aaa table”, but the various information may also be expressed using a data structure other than a table. Therefore, to show that the various information is not dependent on the data structure, “aaa table” can be called “aaa information”.

Furthermore, in the following explanation, there may be cases where an ID (identifier), a number, or the like is used as information for identifying a target of one sort or another instead of a drawing reference sign. However, information for identifying a target of some sort is not limited to an ID (identifier), a number, or the like, and another type of identification information may be used.

In the following explanation, there may be cases where an entity performing a process is explained as being the “data management apparatus”, the “storage apparatus”, or the “edge storage apparatus”. However, this processing may be performed by the control part, the “storage apparatus”, or the “edge storage apparatus”. That is, the processing may be performed, or the disk controller (for example, a MP, which will be explained further below) of the storage apparatus or the edge storage apparatus executing a prescribed program.

Furthermore, in the following explanation, there may be cases where an explanation is given using a “program” as the doer of the action, but since the specified processing is performed in accordance with a program being executed by a processor (for example, a CPU (Central Processing Unit)) while using a storage resource (for example, a memory) and/or a communication interface processor (for example, a communication port), the processor may be regarded as the doer of the processing. A process, which is explained having a program as the doer of the action, may be regarded as a process performed by a device comprising a processor (for example, the storage apparatus, or the edge storage apparatus). Furthermore, either all or a portion of the processing performed by the processor may be carried out by a hardware circuit. A computer program may be installed in various computers from a program source.

Also, in the following explanation, a communication interface apparatus may be abbreviated as “I/F”.

### Example 1

### Overview of Example 1

First, an overview of Example 1 will be explained.

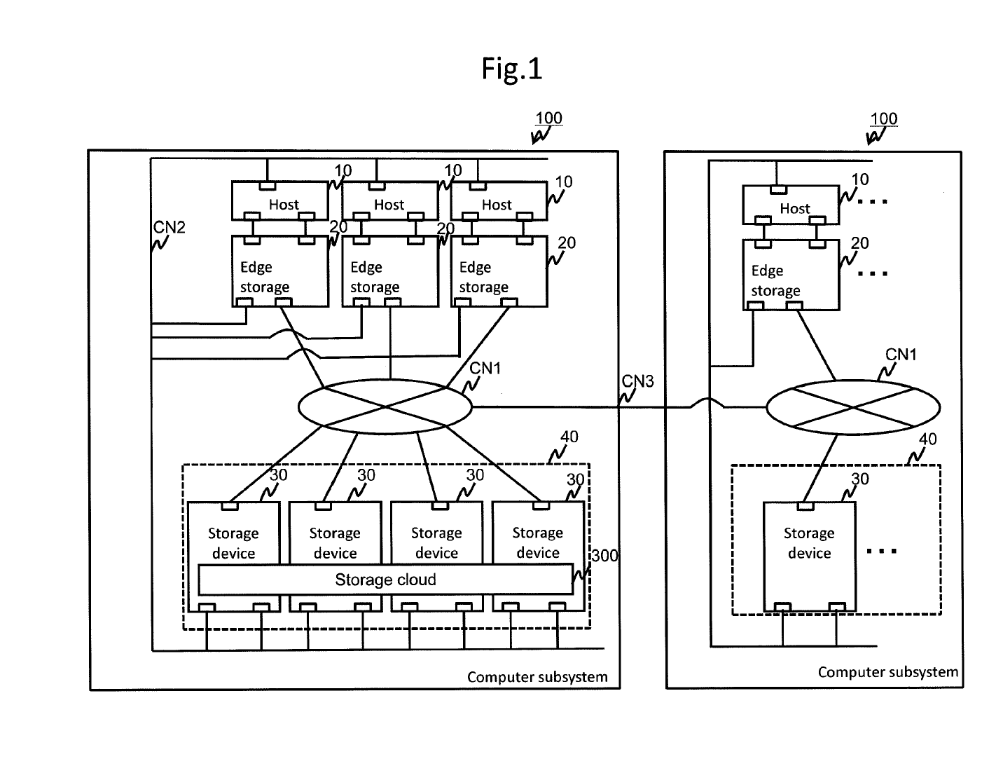

A computer system related to this example comprises one or more computer subsystems 100 (refer to FIG. 1). The computer subsystem 100 comprises one or more computers (referred to as host computer hereinbelow) 10, a storage system 40 comprising one or more storage apparatuses 30, and one or more edge storage apparatuses (edge storage) 20. An edge storage 20 is associated with each host computer 10 on a one-to-one basis. In the computer subsystem 100 the storage apparatus 30 either performs a data write to a physical storage area, or performs a data read from the relevant physical storage area in accordance with an IO request (either a write request or a read request) from the host computer 10.

A storage cloud 300 is configured in the computer system based on a physical storage area of multiple storage apparatus 30 of one or more computer subsystems 100. The storage cloud 300 comprises a global logical storage apparatus (may be abbreviated as GLDEV hereinafter) capable of being uniquely identified in the storage cloud 300.

A LUN (Logical Unit Number) is allocated as an identifier showing a route between the GLDEV and the host I/F 21, which will be explained further below. Host computer 10 is aware of the LUN. A GLDEV number (#), which is uniquely identified in the storage cloud 300, is assigned to the GLDEV. The GLDEV is associated with a local logical storage apparatus (may be abbreviated as LLDEV hereinafter) of the storage system 40. The edge storage 20 correspondingly manages the LUN, which is provided to the host computer 10, and the GLDEV. The edge storage 20 also manages information showing to which LLDEV of which storage apparatus 30 the GLDEV corresponds. For example, the edge storage 20 correspondingly manages the GLDEV, the LLDEV corresponding thereto, and a path (internal path) to this LLDEV.

The LLDEV may be a substantial logical storage apparatus based on either one or multiple physical storage apparatuses of the storage apparatus 30 of the storage system 40, or may be a virtual logical storage apparatus based on a substantial logical storage apparatus of a storage apparatus 30 external to the storage system 40. An LLDEV number (#), which is uniquely identified in the storage apparatus 30 to which the LLDEV belongs, is assigned to the LLDEV.

In a case where volume data is migrated from one LLDEV to another LLDEV in the computer system, the association between the GLDEV and the LLDEV will change pursuant thereto. Specifically, for example, when management is being performed by associating a GLDEV #A with a LLDEV #A in which data #A is stored, and associating a GLDEV #B with a LLDEV #B, in a case where the data #A is migrated from the LLDEV #A to the LLDEV #B, the GLDEV #A is associated with the LLDEV #B. The GLDEV #B may be associated with the LLDEV #A at this time. Since the host computer 10 uses the LUN to access the data #A, the host computer 10 can access desired volume data without being conscious of the migration of the volume data between LLDEVs since the corresponding relationship between the GLDEV corresponding to the LUN and the LLDEV in which the data #A is stored is properly maintained in accordance with this processing.

Each storage apparatus 30 manages information showing with which GLDEV the LLDEV of the storage apparatus 30 is associated, and a path(s) from one or multiple edge storage apparatuses 20 to its own LLDEV (ES-SD path). Also, in a case where a volume copy process is performed (at the least a case in which an initial copy process, which will be explained further below, is performed during a volume copy process) and the corresponding relationship between its own LLDEV and the GLDEV has been changed, each storage apparatus 30, for example, manages a flag (notification necessity/non-necessity flag) indicating whether or not the edge storage 20 needs to be notified of this change.

In an IO process, in a case where an IO request specifying the LUN has been received from the host computer 10, the edge storage 20 identifies the GLDEV from the specified LUN, identifies the destination storage apparatus 30 and the LLDEV from the identified GLDEV, and sends an IO command (an example of an input/output request) specifying the LLDEV to the identified storage apparatus 30. The storage apparatus 30, which receives the IO command, performs either a data write or read with respect to the specified LLDEV.

The computer system related to this example performs the following volume copy process, storage apparatus 30 path translation process, and edge storage 20 path translation process.

### <Volume Copy Process>

The volume copy process is for migrating the volume data in one LLDEV to another LLDEV, and comprises an initial copy process and a difference copy process. The storage apparatus (may be referred to as the copy-source storage apparatus hereinafter) 30, which comprises the copy-source (migration-source) LLDEV, and the storage apparatus (may be referred to as the copy-destination storage apparatus) 30, which comprises the copy-destination (migration destination) LLDEV, both manage the following information.

(*) Copy pair information comprising the copy-source LLDEV number and the GLDEV number, and the copy-destination LLDEV number and the GLDEV number.
(*) Information on an internal path of the copy-source LLDEV and a path (copy path) from the copy-source LLDEV to the copy-destination LLDEV.

In the volume copy process, the volume data of the copy-source LLDEV is completely copied to the copy-destination LLDEV (initial copy process). The storage area inside the LLDEV is segmented into storage areas of prescribed units (for example, blocks) at this time. During the initial copy process, the storage apparatuses 30 manage information showing whether or not a write command has been received for each block of the copy-source LLDEV. As information showing whether or not a write command has been received, there is a bitmap, which uses bits to show whether or not a write command corresponding to each block has been received. Then, the data written to the block targeted by the write command received during the initial copy process is reflected in the copy-destination LLDEV after the initial copy process has ended (difference copy process).

### <Storage Apparatus 30 Path Translation Process>

The performance of an initial copy process between the LLDEVs changes the corresponding relationship between the GLDEV and the LLDEV. Consequently, the storage apparatus 30 involved in the initial copy process associates the GLDEV, which has been associated with the copy-source LLDEV, with the copy-destination LLDEV. Furthermore, the GLDEV, which had been associated with the copy-destination LLDEV, may be associated with the copy-source LLDEV. Specifically, for example, the storage apparatus 30 involved in the initial copy process associates the copy-source GLDEV number with the copy-destination LLDEV number, and associates the copy-destination GLDEV number with the copy-source LLDEV number. Then, the storage apparatus 30 sets the notification necessity/non-necessity flag to indicate that the edge storage 20 needs to be notified with respect to the ES-SD path corresponding to each LLDEV.

Thus, the need to notify the edge storage 20 of the change can be appropriately managed by setting the notification necessity/non-necessity flag with respect to the ES-SD path for which the corresponding relationship between the LLDEV and the GLDEV has changed.

### <Edge Storage 20 Path Translation Process>

In a case where the corresponding relationships between the LLDEVs and the GLDEVs in the storage apparatuses 30 have been changed, this process reflects these changes in the edge storage 20.

Based on an IO request from the host computer 10, the edge storage 20 sends an IO command, which specifies a LLDEV, to the storage apparatus 30. In a case where the notification necessity/non-necessity flag is set for the ES-SD path, the storage apparatus 30, which receives the IO command, notifies the edge storage 20 to the effect that the corresponding relationship between the LLDEV and the GLDEV should be updated. Then, the edge storage 20, which receives this notification, notifies the storage apparatus 30 of information showing the corresponding relationship between LLDEV and the GLDEV of the edge storage 20. The storage apparatus 30, based on the information notified from the edge storage 20 showing the corresponding relationship, sends the edge storage 20 information related to the current LLDEV corresponding to the GLDEV. The edge storage 20 reflects the information related to the current LLDEV sent from the storage apparatus 30 in the information showing the corresponding relationship between LLDEV and the GLDEV of the edge storage 20.

In a case where an IO command (and data accompanying the IO command) is sent from the edge storage 20 to the copy-destination LLDEV during difference copy processing, the copy-destination storage apparatus 30 temporarily stores the IO command, which has been sent, in its own storage area, and executes this IO command subsequent to the difference copy process.

According to the processing described hereinabove, in a case where the corresponding relationship between the LLDEV and the GLDEV of the storage apparatus 30 has been changed, the storage apparatus 30 can, in accordance with an IO command response, prompt all the edge storages 20 via which the ES-SD path is being managed to update the corresponding relationship between the LLDEV and the GLDEV. In addition, the edge storage 20 can acquire information about the current LLDEV corresponding to the GLDEV from the storage apparatus 30 from which there was a response, and can reflect this information in information showing the corresponding relationship between the LLDEV, which it itself is managing, and the GLDEV. In accordance with this, since the edge storage 20 can appropriately manage the corresponding relationship between the copy-destination LLDEV and the LUN of which the host computer 10 is aware even in a case where volume data has been migrated to another LLDEV, the host computer 10 need not be conscious of whether or not a volume copy process is being performed at the time of an IO request. This also does away with the need for the host computer 10 to suspend an application. In addition, since application software does not have to be installed in the host computer 10, the path can be translated subsequent to volume data migration without relying on the host computer 10 OS.

FIG. 1 shows the configuration of a computer system related to Example 1.

The computer system comprises one or more computer subsystems 100. The computer subsystem 100 comprises a host computer (hereinafter referred to as a “host”) 10, an edge storage 20, a data management apparatus 50, a storage system 40 comprising multiple storage apparatuses 30, and communication networks CN1 and CN2. In a case where there are multiple computer subsystems 100, the computer subsystems 100 are coupled via a communication network CN3 as shown in the drawing.

The edge storage 20 is coupled to the host 10. The edge storage 20 is also coupled to multiple storage apparatuses 30 via the communication network CN1. The hosts 10, the respective edge storages 20, and the respective storage apparatuses 30 in the computer subsystem 100 are coupled respectively via the communication network CN2.

The communication network CN1, for example, may be a communication network such as an IP-SAN (Internet Protocol-Storage Area Network) or a FC-SAN (Fibre Channel-SAN). Communication network CN2, for example, may be a communication network such as a LAN (Local Area Network) or the Internet. The communication network CN3, for example, may be a communication network such as a WAN (Wide Area Network) or the Internet.

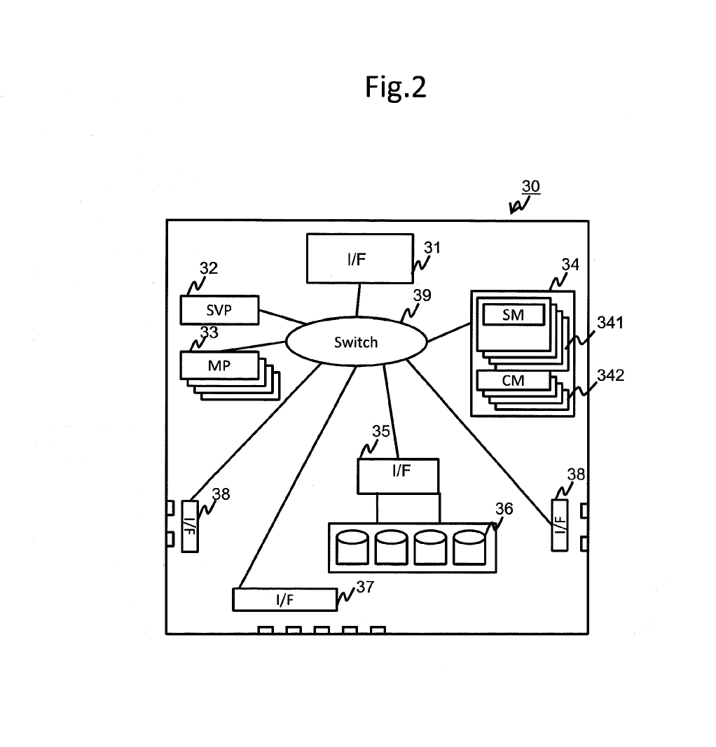

The storage apparatus 30 comprises either one or multiple physical storage devices 36 (refer to FIG. 2). Multiple storage apparatuses 30 are coupled to one another, and multiple LLDEVs based on these multiple storage apparatuses 30 are provided as a single virtual storage area. In this example, this virtual storage area is referred to as the storage cloud 300. The storage cloud 300 comprises multiple virtual LDEVs (GLDEVs), which are associated with multiple LLDEVs based on the storage apparatus 30. Each GLDEV is associated with any of the LLDEVs. A GLDEV number is assigned to the GLDEV, and is uniquely identified in the storage cloud 300. The storage cloud 300 comprises multiple GLDEVs comprising multiple attributes. The storage cloud 300 may be configured based on the LLDEVs of multiple storage apparatuses 30 in a single storage system 40, or may be configured based on the LLDEVs of multiple storage apparatuses 30 of multiple storage systems 40, which span multiple computer subsystems 100 coupled via a communication network CN3. The storage cloud 300 may be hierarchized in accordance with the attributes of multiple LLDEVs, which form the basis thereof. Matters disclosed in Japanese Patent Application Laid-open No. 2009-181402 and US Patent Application Laid-open No. 2009/198942 can be cited with respect to the GLDEV (including the storage cloud) management method, the LLDEV management method, and the method for adding and removing a storage apparatus 30.

The host 10 comprises a CPU and a storage resource (for example, a memory) not shown in the drawing. A computer program is stored in the storage resource. The CPU executes the computer program, which is in the storage resource. A storage resource, for example, stores an application for storing data in the LUN and reading data from the LUN, a hypervisor for building one or more virtual machines (virtual computers), and a program for migrating a virtual machine to another host 10.

One edge storage 20 is coupled to one host 10. That is, a host 10 and an edge storage 20 form one pair. This pair of a host 10 and an edge storage 20 may be referred to as a host group. In this drawing, three host groups are shown, but the number of host groups is not limited thereto. There may be one host group, or there may be two or more host groups. This drawing shows an example in which a host 10 and an edge storage 20 are configured in different enclosures and are coupled, but the edge storage 20, for example, may be configured using a slot card and coupled to the host 10 by being incorporated inside the same enclosure as the host 10.

FIG. 2 shows the configuration of the storage apparatus 30.

The storage apparatus 30, for example, can be broadly divided into a control part (disk controller) and a storage part. The storage part comprises multiple physical storage devices 36. For example, a RAID (Redundant Arrays of Inexpensive Disks) group may be configured in the storage apparatus 30 using multiple physical storage devices 36. The types of physical storage devices 36 may include a SSD (Solid State Drive), SAS Serial Attached SCSI)-HDD (Hard Disk Drive), and a SATA (Serial ATA)-HDD.

The storage apparatus 30 forms either one or multiple logical storage apparatuses (LLDEV), which are logical storage areas based on physical storage areas of one or more physical storage devices 36. The LLDEV may be a virtual LLDEV based on an LLDEV of a storage apparatus 30, which exists externally to the storage system 40.

Each LLDEV comprises various attributes. The attributes of each LLDEV, for example, are based on the performance and bit-cost of the physical storage device 36, and the communication speed of the communication equipment related to the physical storage device 36 constituting the basis of the LLDEV. The performance of the physical storage device 36 depends on the type of physical storage device 36, the RAID level, and the configuration (combination) of the RAID group.

The control part of the storage apparatus 30, for example, comprises a edge storage I/F 31, a service processor (abbreviated as SVP hereinafter) 32, a microprocessor (abbreviated as MP hereinafter) 33, a memory 34, a disk I/F 35, an I/F 38, and an I/F 37.

The edge storage I/F 31 is a communication I/F for carrying out communications between respective parts of the edge storage 20 and the storage apparatus 30, and for carrying out communication between storage apparatuses 30. Specifically, for example, the edge storage I/F 31 is a fibre channel (abbreviated as FC hereinafter), and makes it possible to carry out communications with the host 10 by way of the edge storage 20. The edge storage I/F 31 may be configured as a microcomputer system comprising a CPU and a memory. The edge storage I/F 31 comprises either one or multiple ports, and, for example, a network address such as WWN (World Wide Name) is associated with the port(s).

The disk I/F 35 is a communication I/F for carrying out communications between respective parts inside the storage apparatus 30 (as used here, the edge storage I/F 31, the SVP 32, the MP 33, the memory 34, the I/F 37, and the I/F 38) and a physical storage device 36. The disk I/F 35 may be configured as a microcomputer system comprising a CPU and a memory.

The memory 34 comprises one or more shared memories (abbreviated as SM hereinafter) 341 and one or more cache memories (abbreviated as CM hereinafter) 342. The SM 341 stores various types of programs for controlling the storage apparatus 30. The SM 341 also comprises a working area. In addition, the SM 341 stores various types of tables, which will be explained further below.

The CM 342 stores various types of commands and data received from the edge storage 20. The CM 342 also stores data sent from the disk I/F 35.

The MP 33 executes various types of processing in accordance with executing a program stored in the SM 341. For example, the MP 33 executes processing corresponding to an IO command or various types of commands sent from the edge storage 20, and controls the transfer of data to/from the host 10. In addition, the MP 33 executes volume copy processing between LLDEVs, and controls the transfer of data to another storage apparatus 30.

The I/F 38 is for coupling another storage apparatus 30. Multiple storage apparatuses 30 can be coupled in series via the storage I/F 38. The storage cloud 300 may be formed in accordance with multiple storage apparatuses being coupled in series.

The I/F 37 is for carrying out communications with another apparatus coupled to a communication network CN2.

The SVP 32, for example, is a type of computer, and is used to either maintain or manage the storage apparatus 30. For example, the SVP 32 configures information related to the storage apparatus 30, and receives and displays information related to the storage apparatus 30.

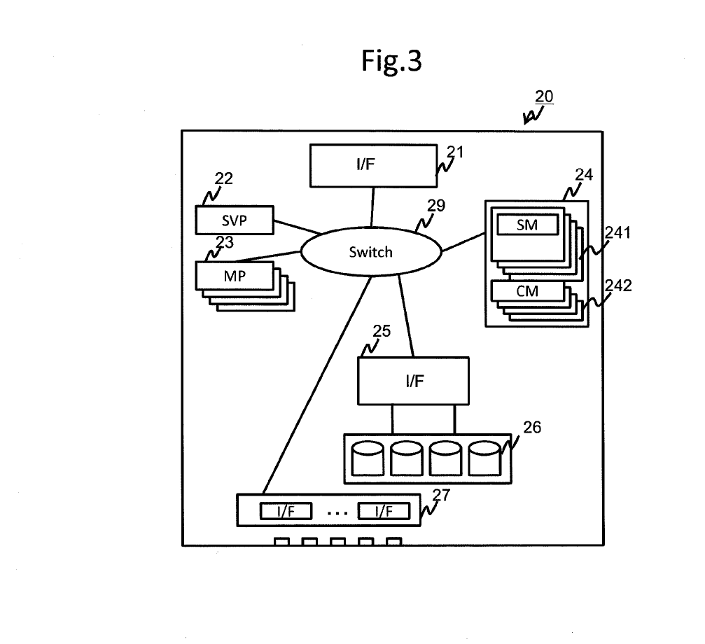

FIG. 3 is a diagram showing the configuration of the edge storage 20.

The edge storage 20 is coupled to each host 10 on a one-to-one basis. In this example, the edge storage 20 is not directly coupled to another host 10 or another edge storage apparatus 20. The edge storage 20 basically constitutes the same configuration as the storage apparatus 30 with the exception of not comprising an I/F corresponding to the I/F 38 shown in FIG. 2 for coupling to another apparatus (for example, another edge storage 20). Explanations of the same configurations as those of the storage apparatus 30 may be omitted. The edge storage 20, for example, can be broadly divided into a control part (disk controller) and a storage part. The storage part comprises multiple physical storage apparatuses 26. The physical storage apparatus 26, for example, is a storage media, such as a hard disk drive (HDD), a flash memory drive, or the like. The capacity of the physical storage apparatus 26 may be smaller than the capacity of the physical storage device 36 of the storage apparatus 30. The edge storage 20 need not comprise the physical storage apparatus 26. The control part, for example, comprises a host I/F 21, a SVP 22, one or more MPs 23, a memory 24, a disk I/F 25, and an I/F 27.

The host I/F 21 is a communication I/F for carrying out communications between the host 10 and respective parts inside the edge storage 20. Specifically, for example, the host I/F 21 may be a PCI express (abbreviated as PCIe hereinafter) or the like. The host I/F 21 may be configured as a microcomputer system comprising a CPU and a memory. The host I/F 21 comprises either one or multiple ports, and, for example, a network address such as WWN is associated with the port(s).

The disk I/F 25 is for carrying out communications between respective parts inside the edge storage 20 (as used here, the host I/F 21, the SVP 22, the MP 23, the memory 24, and the storage I/F 27) and the physical storage apparatus 26.

The memory 24 comprises one or more SMs 241, and one or more CMs 242. The SM 241 stores various types of programs for controlling the edge storage 20. The SM 241 also comprises a working area. In addition, the SM 241 stores various types of tables, which will be explained further below.

The CM 242 stores various types of requests and data sent from the host 10. In addition, the CM 242 stores data sent from the storage apparatus 30.

The MP 23 executes various types of processing in accordance with executing a program stored in the SM 241. For example, the MP 23 executes processing corresponding to an IO request and various other types of requests sent from the host 10, and controls the transfer of data to/from the host 10. The MP 23 also controls the transfer of data to/from the storage apparatus 30.

The SVP 22, for example, is a type of computer, and is used to either maintain or manage the edge storage 20.

The storage I/F 27 is for carrying out communications with a storage apparatus 30. The storage I/F 27 may be configured as a microcomputer system comprising a CPU, a memory, and so forth.

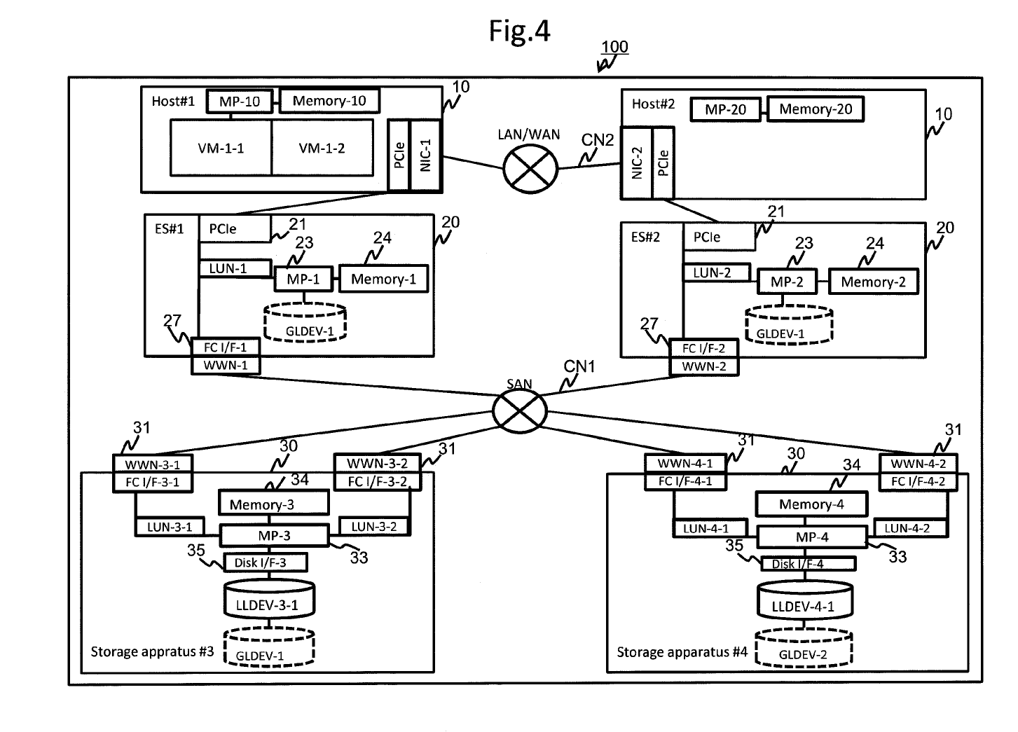

FIG. 4 shows the state of the computer subsystem 100 related to Example 1 at a certain point in time. It is supposed here that the certain point in time is the point in time prior to the start of a copy.

An example of a case in which there are two host groups (host (Host) #1 and edge storage (ES) #1 and host (Host) #2 and edge storage (ES) #2), and two storage apparatuses 30 (storage apparatus (Storage apparatus) #3 and storage apparatus #4) in the computer subsystem 100 will be explained below.

FIG. 4 shows an example in which the edge storage I/F 31 of the storage apparatus 30 uses a FC, and FC I/F-n-n (where n is a numeral) is written in the same drawing.

An NIC-1, which is the NIC (network I/F card) of the host #1, and an NIC-2 of the host #2 are coupled via the communication network CN2. The host #1 and the edge storage #1 are coupled via PCIe. The host #2 and the edge storage #2 are also coupled via PCIe. An FC I/F-1 of the edge storage #1, an FC I/F-2 of the edge storage #2, an FC I/F-3-1 and an FC I/F-3-2 of the storage apparatus #3, and an FC I/F-4-1 and an FC I/F-4-2 of the storage apparatus #4 are mutually coupled via a communication network CN1.

A VM-1-1 and a VM-1-2, which are virtual machines, are built in the host #1 in accordance with a MP-10 executing a hypervisor stored in a memory (Memory)-10. Alternatively, a virtual machine has not been built in the host #2 at this point in time, but a hypervisor is stored in a memory-20. The VM-1-1 and the VM-1-2 of the host #1 can recognize a LUN-1, which is a logical volume.

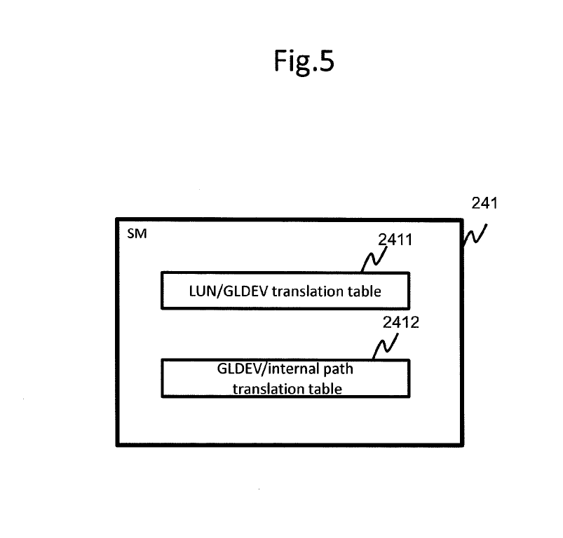

An LUN recognizable by the host 10 and a GLDEV number (GLDEV #) are associated and managed in the edge storage 20. The memory 24 of each edge storage 20 stores the association information of the LUN and the GLDEV number (for example, an LUN/GLDEV translation table 2411 (refer to FIG. 5)). The memory-1 of the ES #1 stores the association information of a GLDEV-1 and a LUN-1. The memory-2 of the ES #2 stores the association information of a GLDEV-2 and a LUN-2. In addition, the memory 24 of each edge storage 20 stores the association information of a GLDEV and a path to the corresponding LLDEV (for example, a GLDEV/internal path translation table 2412 (refer to FIG. 5)). At this point in time, the GLDEV-1 corresponds to the LLDEV-3-1, and the GLDEV-2 corresponds to the LLDEV-4-1, and as such, the memory-1 of the ES #1 and the memory-2 of the ES #2 store the association information of the GLDEV-1 and the internal path to the LLDEV-3-1, and the association information of the GLDEV-2 and the internal path to the LLDEV-4-1, respectively.

A unique LLDEV number is assigned to the LLDEV inside each storage apparatus 30. The LLDEV is associated with a GLDEV. The association information of the LLDEV and the GLDEV is stored in the memory 34 of each storage apparatus 30. The memory-3 of the storage apparatus #3 stores the association information of the LLDEV-3-1 and the GLDEV-1. The memory-4 of the storage apparatus #4 stores the association information of the LLDEV-4-1 and the GLDEV-2.

A WWN is allocated to the edge storage I/F 31. In the storage apparatus #3, a WWN-3-1 is allocated to the FC I/F-3-1 and a WWN-3-2 is allocated to the FC I/F-3-2. In the storage apparatus #4, a WWN-4-1 is allocated to the FC I/F-4-1 and a WWN-4-2 is allocated to the FC I/F-4-2.

A LUN is allocated as an identifier showing a route between the edge storage I/F 31 and the LLDEV. Therefore, it is possible to identify a LLDEV by specifying a WWN and a LUN. In the edge storage 20, the path to a LLDEV, for example, is the WWN-LUN pair comprising the route to the LLDEV. A LUN-3-1 is allocated to the route between a WWN-3-1 and a LLDEV-3-1, and a LUN-3-2 is allocated to the route between a WWN-3-2 and a LLDEV-3-1. In the storage apparatus #4, a LUN-4-1 is allocated to the route between a WWN-4-1 and a LLDEV-4-1, and a LUN-4-2 is allocated to the route between a WWN-4-2 and a LLDEV-4-1.

The configuration of the memory 24 (more specifically, SM 241) of the edge storage 20 will be explained next.

FIG. 5 is a block diagram of the memory of the edge storage 20.

The SM 241 stores a LUN/GLDEV translation table 2411, a GLDEV/internal path translation table 2412, and a control program (not shown in the drawing). The LUN/GLDEV translation table 2411 is for storing the corresponding relationship between a LUN and a GLDEV. The GLDEV/internal path translation table 2412 is for managing a path (hereinafter, may be referred to as internal path) for accessing a LLDEV associated with a GLDEV. The control program is for performing internal processing in its own edge storage 20, and for performing processing for sending/receiving data or a command to/from another apparatus.

Next, tables stored in the edge storage #1 and the edge storage #2 will be explained as examples of the LUN/GLDEV translation table 2411 and the GLDEV/internal path translation table 2412. The LUN/GLDEV translation table 2411 of the edge storage #1 will be called the LUN/GLDEV translation table 2411A, and the LUN/GLDEV translation table 2411 of the edge storage #2 will be called the LUN/GLDEV translation table 2411B. Also, the GLDEV/internal path translation table 2412 of the edge storage #1 will be called the GLDEV/internal path translation table 2412A, and the GLDEV/internal path translation table 2412 of the edge storage #2 will be called the GLDEV/internal path translation table 2412B.

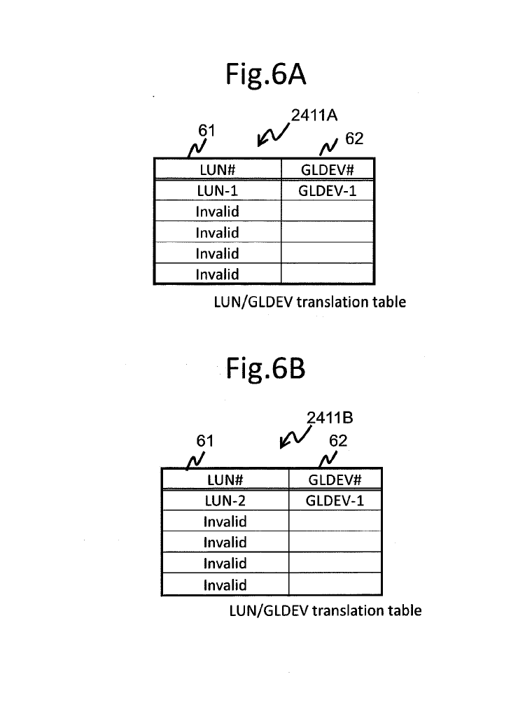

FIG. 6A is an example of the LUN/GLDEV translation table 2411A of the edge storage #1. FIG. 6B is an example of the LUN/GLDEV translation table 2411B of the edge storage #2. FIGS. 6A and 6B show a case in which the computer subsystem 100 is in the state shown in FIG. 4, that is, an example in which the content of each table is at a point in time prior to the start of a copy.

The LUN/GLDEV translation table 2411 (2411A, 2411B) associates the edge storage's 20 own LUN with the GLDEV inside the storage cloud 300. For example, the LUN/GLDEV translation table 2411 comprises the following information for each LUN.

(*) A LUN #61, which is an example of an LUN identifier, that is, identification information for identifying a volume.
(*) A GLDEV #62, which is the identifier (global identification information) of the GLDEV associated with the LUN.

The LUN/GLDEV translation table 2411A shown in FIG. 6A shows that the GLDEV-1 is associated with the LUN-1, which is provided to the host #1.

The LUN/GLDEV translation table 2411B shown in FIG. 6B shows that the GLDEV-1 is associated with the LUN-2, which is provided to the host #2.

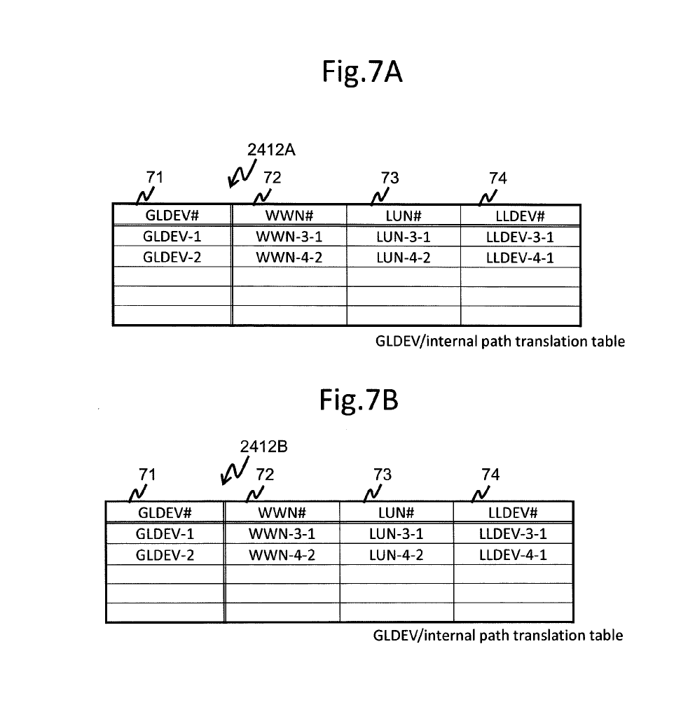

FIG. 7A is an example of the GLDEV/internal path translation table of the edge storage #1. FIG. 7B is an example of the GLDEV/internal path translation table of the edge storage #2.

FIGS. 7A and 7B show a case in which the computer subsystem 100 is in the state shown in FIG. 4, that is, an example in which the content of each table is at a point in time prior to the start of a copy.

The GLDEV/internal path translation table 2412 (2412A, 2412B) stores the corresponding relationship between a unique GLDEV inside the storage cloud 300 and a path (internal path: access information) to the LLDEV corresponding to the GLDEV. For example, the GLDEV/internal path translation table 2412 comprises the following information for each GLDEV.

(*) A GLDEV #71, which is the GLDEV identifier.
(*) A WWN #72, which is the identifier of a port of the storage apparatus 30 edge storage I/F 31 coupled to the LLDEV corresponding with the GLDEV.
(*) A LUN #73, which shows the route from the edge storage I/F 31 corresponding to the WWN #72 to the LLDEV.
(*) A LLDEV #74, which is the identifier of the LLDEV corresponding to the GLDEV.

The GLDEV/internal path translation table 2412A shown in FIG. 7A shows that the internal path to the LLDEV-3-1 corresponding to the GLDEV-1 is the path via the WWN-3-1 and the LUN-3-1, and that the internal path to the LLDEV-4-1 corresponding to the GLDEV-2 is the path via the WWN-4-2 and the LUN-4-2. The GLDEV/internal path translation table 2412 may store information corresponding to all the GLDEVs inside the storage cloud 300. In this example, the GLDEV/internal path translation table 2412 stores information corresponding to all the GLDEVs, and the GLDEV/internal path translation table 2412B shown in FIG. 7B comprises the same content as the GLDEV/internal path translation table 2412A shown in FIG. 7A.

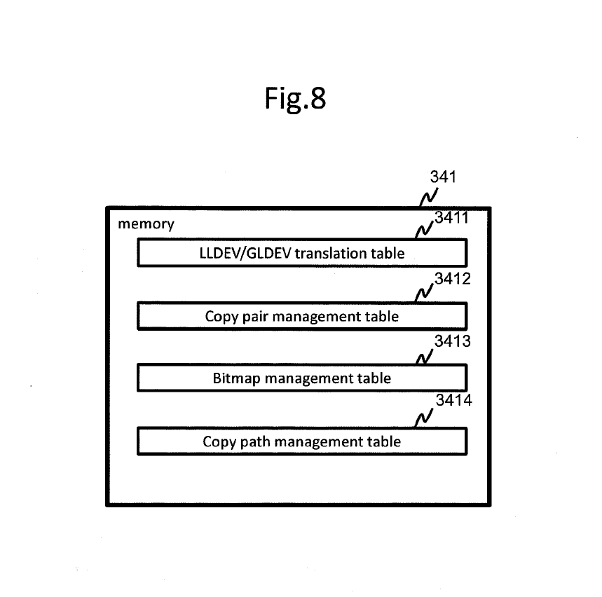

FIG. 8 is a block diagram of the memory of the storage apparatus 30.

The SM 341 stores a LLDEV/GLDEV translation table 3411, a copy pair management table 3412, a bitmap management table 3413, a copy path management table 3414, and a control program (not shown in the drawing). The LLDEV/GLDEV translation table 3411 is for associating and storing a LLDEV number and a GLDEV number. The copy pair management table 3412 is for managing a copy pair (a copy source and a copy destination) in a volume copy process. The bitmap management table 3413 uses a bitmap to manage a write to a copy-source LLDEV during a volume copy process (specifically, the initial copy process of the volume copy process). The copy path management table 3414 is for managing the path in a volume copy process. The control program is for the storage apparatus 30 to perform its own internal processing, and to perform processing related to the sending/receiving of data and commands to/from another apparatus.

Next, the tables stored in the storage apparatus #3 and the storage apparatus #4 shown in FIG. 4 will be explained as examples of the respective tables 3411, 3412, 3413, and 3414. The tables stored in the storage apparatus #3 will be referred to as a LLDEV/GLDEV translation table 3411A, a copy pair management table 3412A, a bitmap management table 3413A, and a copy path management table 3414A, and the tables stored in the storage apparatus #4 will be referred to as a LLDEV/GLDEV translation table 3411B, a copy pair management table 3412B, a bitmap management table 3413B, and a copy path management table 3414B.

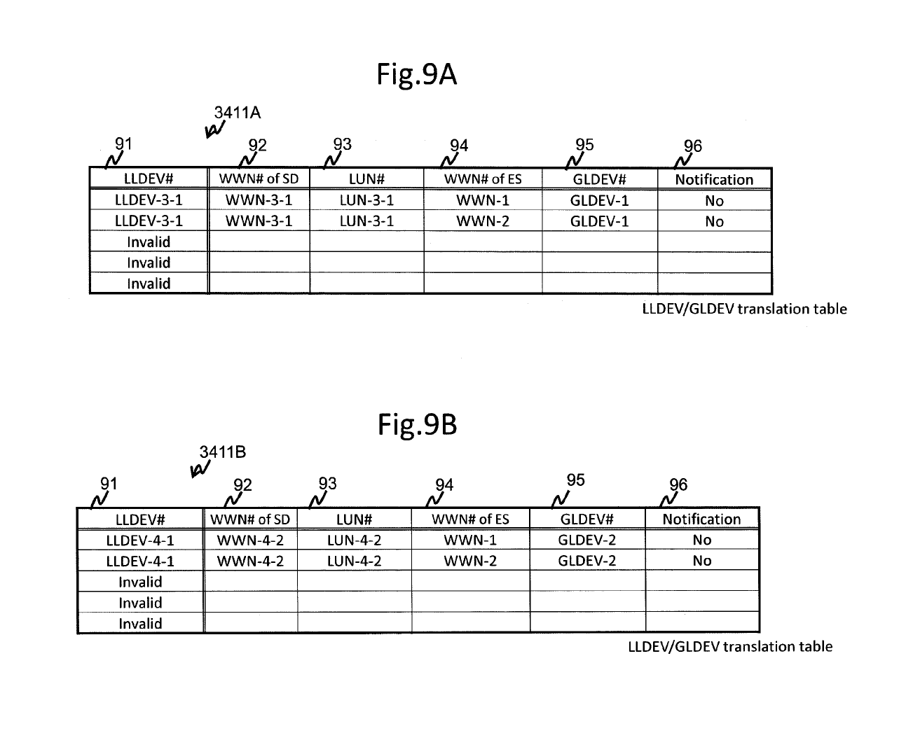

FIG. 9A is an example of the LLDEV/GLDEV translation table of the storage apparatus #3. FIG. 9B is an example of the LLDEV/GLDEV translation table of the storage apparatus #4. FIGS. 9A and 9B show a case in which the computer subsystem 100 is in the state shown in FIG. 4, that is, an example in which the content of each table is at a point in time prior to the start of a copy.

The LLDEV/GLDEV translation table 3411 (3411A, 3411B) is for associating the storage apparatus's 30 own LLDEV with the GLDEV inside the storage cloud 300. For example, the LLDEV/GLDEV translation table 3411 comprises the following information for each path (ES-SD path) from the edge storage 20 to the LLDEV of its own storage apparatus 30.

(*) A LLDEV #91, which is the identifier of the LLDEV managed by the storage apparatus 30 itself.
(*) A SD WWN #92, which is the identifier of a port of the edge storage I/F 31 of its own storage apparatus (SD) 30.
(*) A LUN #93, which shows the route from the port of the edge storage I/F 31 corresponding to the WWN to the LLDEV.
(*) A ES WWN #94, which is the WWN of the edge storage 20 storage I/F 27 for accessing the LLDEV.
(*) A GLDEV #95, which is the identifier of the GLDEV corresponding to the LLDEV.
(*) A notification 96 for showing whether or not it is necessary to notify the edge storage 20 of information in a relevant row (record). The notification 96 is configured to “yes” in a case where the corresponding relationship between the GLDEV and the SD WWN and LUN has changed. The notification 96 is configured to “no” in a case where the corresponding relationship between the GLDEV and the SD WWN and LUN has not changed, and a case in which the information of the relevant row has been notified to the edge storage 20.

The LLDEV/GLDEV translation table 3411A shown in FIG. 9A shows that the LLDEV-3-1 of its own storage apparatus #3 is associated with the GLDEV-1, and that the ES-SD paths to the LLDEV-3-1 are a path via the WWN-1, the WWN-3-1, and the LUN-3-1 of the edge storage #1, and a path via the WWN-2, the WWN-3-1, and the LUN-3-1 of the edge storage #2.

The LLDEV/GLDEV translation table 3411B shown in FIG. 9B shows that the LLDEV-4-1 of its own storage apparatus #4 is associated with the GLDEV-2, and that the ES-SD paths to the LLDEV-4-1 are a path via the WWN-1, the WWN-4-2, and the LUN-4-2 of the edge storage #1, and a path via the WWN-2, the WWN-4-2, and the LUN-4-2 of the edge storage #2.

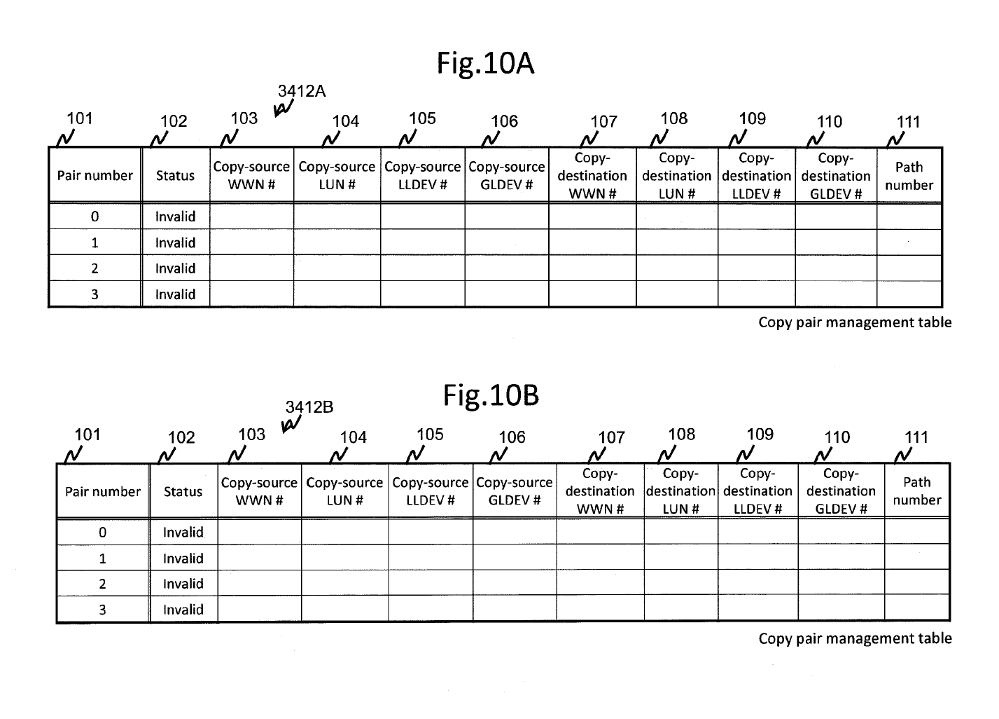

FIG. 10A is an example of the copy pair management table of the storage apparatus #3. FIG. 10B is an example of the copy pair management table of the storage apparatus #4. FIGS. 10A and 10B show examples of the content of each table in a case in which the computer subsystem 100 is in the state shown in FIG. 4.

The copy pair management table 3412 (3412A, 3412B) is for managing information of a copy pair (a copy-source LLDEV and a copy-destination LLDEV), and, for example, manages a path for identifying the copy-source LLDEV and a path for identifying the copy-destination LLDEV. The information in the copy pair management table 3412, for example, is configured by the administrator via the SVP 32 when a volume copy is to be executed. The copy pair management table 3412 comprises the following information for each copy pair of a copy-source LLDEV and a copy-destination LLDEV.

(*) A pair number 101 for identifying a copy pair.
(*) A status 102 for showing the status of the copy pair. The status 102 is configured as “invalid”, “initial copy”, “difference copy”, “notification required”, and “deletable”, and so forth. The status 102 is configured to “invalid” in a case where the content of the copy pair in the same row is invalid, is configured to “initial copy” in a case where an initial copy process is being performed from the copy-source LLDEV to the copy-destination LLDEV, is configured to “difference copy” in a case where a difference copy process is being performed for reflecting update data generated at the time of the initial copy process, is configured to “notification required” in a case where it is necessary to notify the edge storage 20 of the fact that the corresponding relationship between the LLDEV corresponding to the copy pair and the GLDEV has changed, and is configured to “deletable” in a case where it is no longer necessary to notify the edge storage 20 of the fact that the corresponding relationship between the LLDEV corresponding to the copy pair and the GLDEV has changed.
(*) A copy-source WWN #103, which is the identifier of a port of the edge storage I/F 31 of the storage apparatus 30 comprising the copy-source LLDEV.
(*) A copy-source LUN #104 showing the route from the port denoting the copy-source WWN to the copy-source LLDEV.
(*) A copy-source LLDEV #105, which is the identifier of the copy-source LLDEV.
(*) A copy-source GLDEV #106, which is the identifier of the GLDEV corresponding to the copy-source LLDEV.
(*) A copy-destination WWN #107, which is the identifier of a port of the edge storage I/F 31 of the storage apparatus 30 comprising the copy-destination LLDEV.
(*) A copy-destination LUN #108 showing the route from the port denoting the copy-destination WWN to the copy-destination LLDEV.
(*) A copy-destination LLDEV #109, which is the identifier of the copy-destination LLDEV.
(*) A copy-destination GLDEV #110, which is the identifier of the GLDEV corresponding to the copy-destination LLDEV.
(*) A path number 111, which is the identifier of the copy path from the copy-source LLDEV to the copy-destination LLDEV. The copy path from the copy-source LLDEV to the copy-destination LLDEV is stored in the row corresponding to the path number 111 of the copy path management table 3414A.

The copy pair management tables 3412A and 3412B shown in FIGS. 10A and 10B show that a copy pair has not been configured.

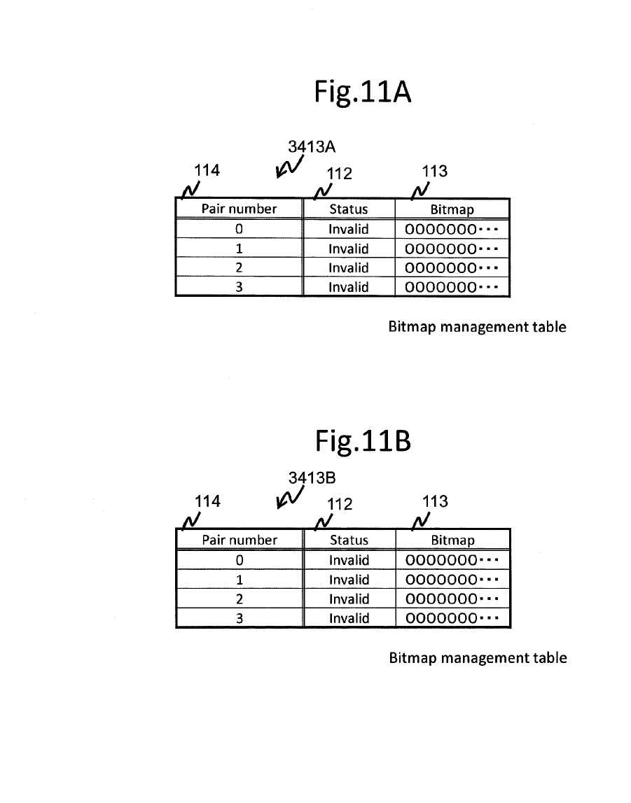

FIG. 11A is an example of a bitmap management table of storage apparatus #3. FIG. 11B is an example of a bitmap management table of storage apparatus #4. FIGS. 11A and 11B show examples of the content of each table in a case in which the computer subsystem 100 is in the state shown in FIG. 4.

The bitmap management table 3413 (3413A, 3413B) stores information related to a bitmap showing whether or not copying is necessary for each prescribed size-partitioned storage area (referred to as a block) in the logical storage area of a specified LLDEV during a volume copy process. For example, the bitmap management table 3413 comprises the following information for each copy pair.

(*) A pair number 114 for identifying a copy pair.
(*) A status 112 for showing the status related to the bitmap. The status 112 is configured to “invalid” in a case where the bitmap is invalid, is configured to “valid” in a case where the bitmap is valid, is configured to “not transferred” in a case where the bitmap has not been transferred from the copy-source storage apparatus 30 to the copy-destination storage apparatus 30, and is configured to “transferred” in a case where the transfer of the bitmap from the copy-source storage apparatus 30 to the copy-destination storage apparatus 30 has ended.
(*) A bitmap 113, which is an aggregate of bits showing whether or not copying has been completed for each block comprising the copy-source LLDEV of the copy pair. The bitmap uses a bit value (either a “0” or a “1”) to show whether or not a copy is necessary for each block of the copy-source LLDEV (in other words, whether or not the copying of the latest data of this block has been completed). For example, in a case where a block corresponding to a bit needs to be copied, the bit is configured to “1”, and is a case where copying is not needed, is configured to “0”. The bitmap, for example, is managed as follows. For example, all the bits in the bitmap 113 are configured to “1” prior to a volume copy process, and a bit corresponding to a block for which copying in accordance with the initial copy process of the volume copy process has ended is changed to “0”. In a case where new data has been written to a block for which a data copy was completed in the initial copy process, the bit corresponding to the block to which the data was written is configured to “1”. This makes it possible to appropriately identify, based on the bitmap, a block in which an update was generated during the initial copy process of the volume copy process.

The bitmap management tables 3413A and 3413B shown in FIGS. 11A and 11B show the bitmap as “invalid” since a volume copy process has not been performed.

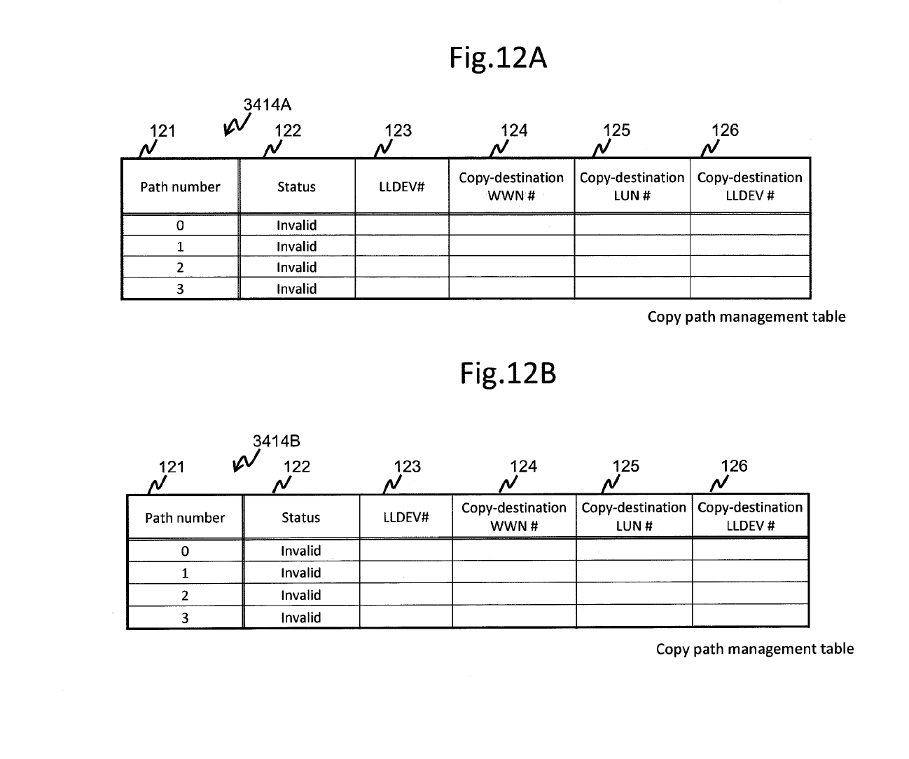

FIG. 12A is an example of a copy path management table of storage apparatus #3. FIG. 12B is an example of a copy path management table of storage apparatus #4. FIGS. 12A and 12B show examples of the content of each table in a case in which the computer subsystem 100 is in the state shown in FIG. 4.

The copy path management table 3414 (3414A, 3414B) stores information showing the corresponding relationship between a copy-source LLDEV and an internal path to a copy-destination LLDEV of a copy-destination storage apparatus 30. The information configured in the copy path management table 3414 may be configured for the copy source only. For example, the copy path management table 3414 comprises the following information for each copy path.

(*) A path number 121, which is the identifier of a copy path. The path number 121 corresponds to the path number 111 of the row corresponding to the same copy pair of the copy pair management table 3412.
(*) A status 122 showing the status of the copy path. The status 122 is configured to “valid” in a case where the copy path is valid, that is, a case in which a volume copy process is in progress, and is configured to “invalid” in a case where the copy path is not valid.
(*) A copy-source LLDEV #123, which is the identifier of the copy-source LLDEV.
(*) A copy-destination WWN #124, which is the identifier of the edge storage I/F 31 port of the storage apparatus 30 storing the copy-destination LLDEV.
(*) A copy-destination LUN #125 showing the route from the port corresponding to the copy-destination WWN to the copy-destination LLDEV.
(*) A copy-destination LLDEV #126, which is the identifier of the copy-destination LLDEV.

The copy path management tables 3414A and 3414B shown in FIGS. 12A and 12B show that a copy pair has not been configured, and as such, valid information has not been configured.

Processing related to the computer subsystem 100 related to Example 1 will be explained next.

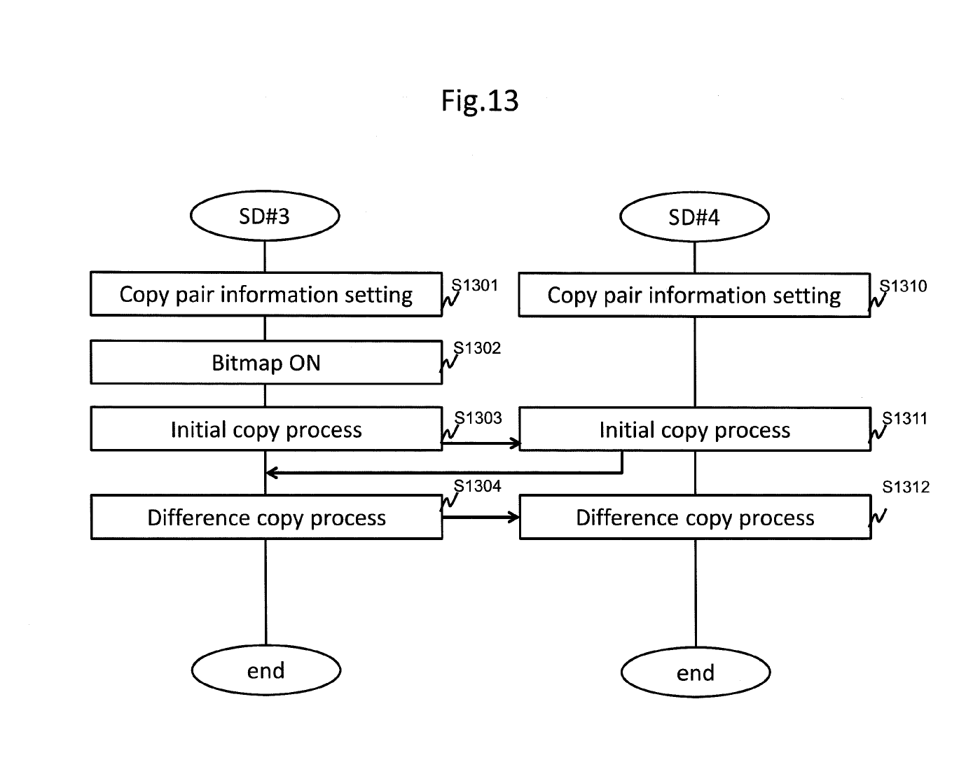

FIG. 13 is a flowchart of volume copy processing.

The volume copy process is performed by the control parts of the copy-source storage apparatus (copy-source storage apparatus) 30 and the copy-destination storage apparatus (copy-destination storage apparatus) 30. Specifically, in each storage apparatus 30 the volume copy process is performed in accordance with the MP 33 executing a program stored in the memory 34. The volume copy process, for example, may be performed in accordance with a user (administrator) instruction, or may be performed in accordance with a preconfigured trigger. A case in which a user instruction is inputted from an input/output device (not shown in the drawing) coupled to the SVP 32 of the copy-source storage apparatus 30 will be explained, but the user instruction may be inputted from the host 10 or inputted in accordance with another method. An example of the computer subsystem 100 show in FIG. 4 will be given here, and a case in which the copy-source storage apparatus 30 is the storage apparatus #3, and the copy-destination storage apparatus 30 is the storage apparatus #4 will be explained. A volume copy process between other storage apparatuses 30 is the same. That is, in the following explanation, the storage apparatus #3 and the storage apparatus #4 may be read as the copy-source storage apparatus 30 and the copy-destination storage apparatus 30.

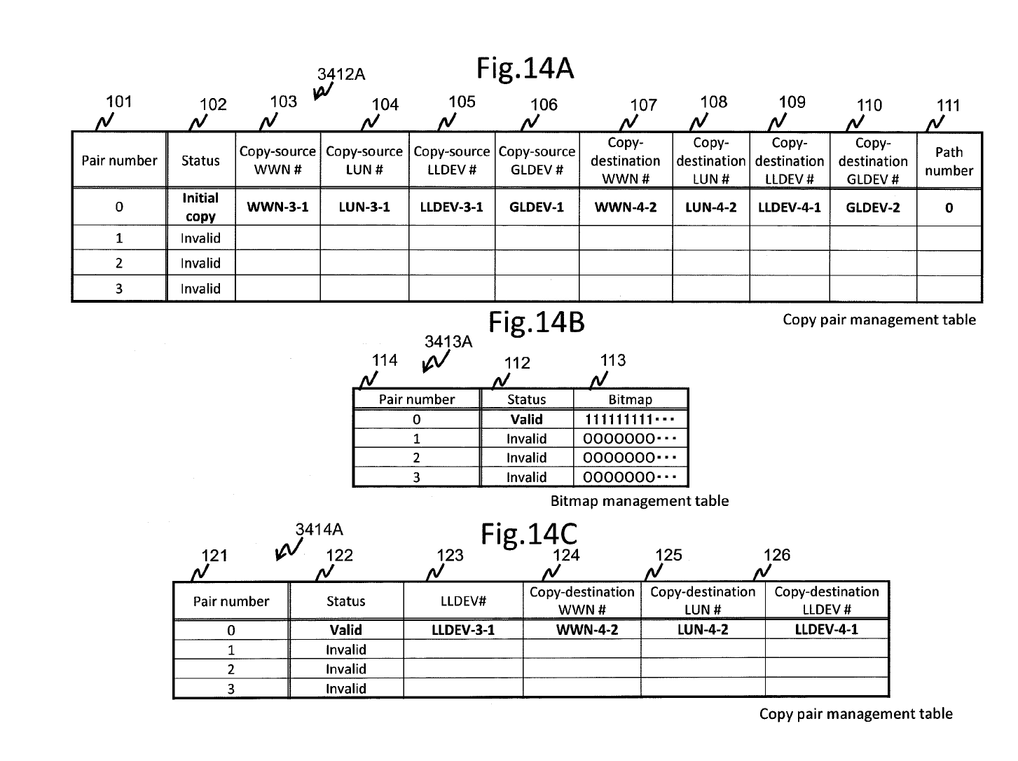

(*) In Step S1301, the storage apparatus #3 receives copy pair information (the copy-source LLDEV number, the copy-source GLDEV number, the copy-destination LLDEV number, and the copy-destination GLDEV number) sent by the user via the SVP 32. Then, the storage apparatus #3 references the LLDEV/GLDEV translation table 3411A shown in FIG. 9A, configures the copy pair information, the copy-source WWN #, the copy-source LUN #, the copy-destination WWN #, the copy-destination LUN #, and the status of the copy pair in a new row of the copy pair management table 3412A, and, in addition, configures a path number in this row. For example, in a case where copy pair information in which the “LLDEV-3-1” and the “GLDEV-1” are the copy source and the “LLDEV-4-1” and the “GLDEV-2” are the copy destination, as shown in FIG. 14A, in the row in which the pair number 101 of the copy pair management table 3412A is “0”, the storage apparatus #3 configures the copy-source GLDEV #106 to “GLDEV-1”, configures the copy-source LLDEV #105 to “LLDEV-3-1”, configures the copy-source LUN #104 to “LUN-3-1”, configures the copy-source WWN #103 to “WWN-3-1”, configures the copy-destination GLDEV #110 to “GLDEV-2”, configures the copy-destination LLDEV #109 to “LLDEV-4-1”, configures the copy-destination LUN #108 to “LUN-4-2”, configures the copy-destination WWN #107 to “WWN-4-2”, configures the path number 111 to “0”, and configures the status 102 to “initial copy”.

The storage apparatus #3 also configured the row corresponding to the path number configured in the copy pair management table 3412A to the copy path management table 3414A. Specifically, the storage apparatus #3, as shown in FIG. 14C, in the row in which the path number 121 is “0” in the copy path management table 3414A, configures the LLDEV #123 to “LLDEV-3-1”, configures the copy-destination WWN #124 to “WWN-4-2”, configures the copy-destination LUN #125 to “LUN-4-2”, configures the copy-destination LLDEV #126 to “LLDEV-4-1”, and in a case where the path is valid, configures the status 122 to “valid”.

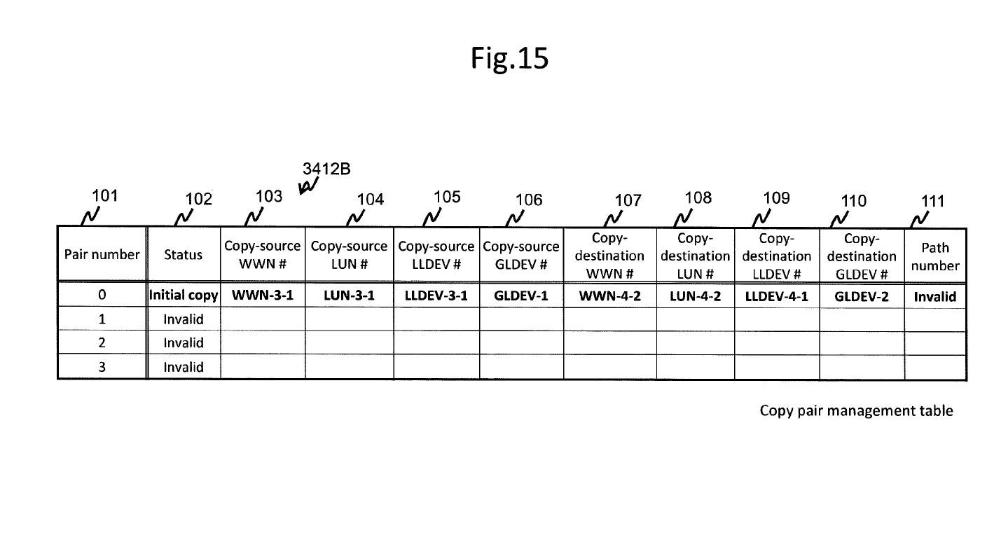

(*) In Step S1310, the storage apparatus #4 configures the copy pair information in the copy pair management table 3412B. The copy pair information may be notified from the storage apparatus #3, or may be inputted by another user from the input/output device (not shown in the drawing) coupled to the SVP 32 of either the host 10 or the storage apparatus #4. The storage apparatus #4 configures a row with the same information as the information in the row configured in the copy pair management table 3412A of the storage apparatus #3 in the copy pair management table 3412B as shown in FIG. 15. The storage apparatus #4 also configures the pair number 114 of the copy pair management table 3412B to “invalid”.
(*) In Step S1302, the storage apparatus #3 updates the bitmap management table 3413A. Specifically, as shown in FIG. 14B, the storage apparatus #3 configures all the bits of the bitmap 113 in the row in which the pair number 114 is “0” to “1”, which shows that the copying of the latest data is not complete, and configures the status 112 to “valid”.

In Step S1303 and Step S1310, the storage apparatus #3 and the storage apparatus #4 perform an initial copy process for completely copying the volume data of the LLDEV-3-1, which is the copy-source LLDEV, to the LLDEV-4-1, which is the copy-destination LLDEV.

(*) In Step S1303, the storage apparatus #3 specifies the WWN-4-1 and the LLDEV-4-1, and sends the volume data in the LLDEV-3-1 to the storage apparatus #4. The storage apparatus #3 sequentially updates the bits in the bitmap 113 of the bitmap management table 3413A, which correspond to the blocks of the LLDEV-3-1 corresponding to the sent data. Specifically, the storage apparatus #3 configures the bit of the bitmap 113 corresponding to the block, which sent to data, from “1” to “0” in the bitmap management table 3413A. After all of the data of the LLDEV-3-1 has been completely sent, the storage apparatus #3 configures the status 112 of the bitmap management table 3413A to “transfer ended”. Then the storage apparatus #3 notifies the storage apparatus #4 that the sending of the data in the initial copy process has ended.

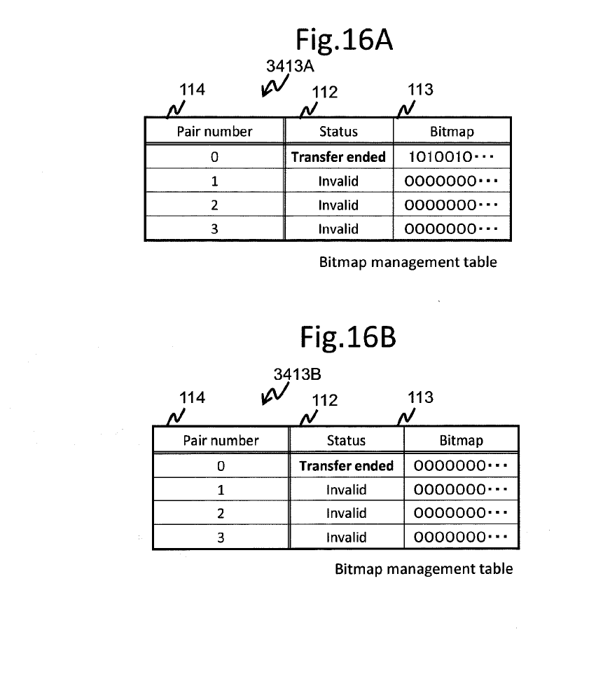

In a case where a write command for any block in the LLDEV-3-1 is received during initial copy processing, the storage apparatus #3 stores the write data based on this write command in its own CM 342, and, in addition, updates the bit(s) of the bitmap 113 corresponding to the write-target block(s) of the bitmap management table 3413A. Specifically, for example, as shown in FIG. 16A, in a case where a write command for a certain block of the LLDEV-3-1 has been received, the storage apparatus #3 configures the bit of the bitmap 113 corresponding to this certain block to “1” and stores the write data in the CM 342. Therefore, in a case where a write command has been received for a block, which has sent data to the storage apparatus #4 one time, the bit of the bitmap 113 corresponding to this block is changed from “0” to “1”. Thus, a block for which the latest data has not been reflected in the storage apparatus #4 can be identified in accordance with referencing the bitmap 113.

(*) In Step S1311, the storage apparatus #4 receives the data sent from the storage apparatus #3, and stores this data in the LLDEV-4-1, which is the copy-destination LLDEV. When the storage apparatus #4 receives the notification from the storage apparatus #3 to the effect that the sending of the data in the initial copy process has ended, the notification-receiving storage apparatus #4 updates the bitmap management table 3413B. Specifically, as shown in FIG. 16B, the storage apparatus #4 configures the status 112 of the bitmap management table 3413B to “transfer ended”. Next, the storage apparatus #4 notifies the storage apparatus #3 to the effect that the initial copy process has ended.
(*) In Step S1304 and Step S1312, the storage apparatus #3 and the storage apparatus #4 perform difference copy processing from the LLDEV-3-1, which is the copy-source LLDEV, to the LLDEV-4-1, which is the copy-destination LLDEV.

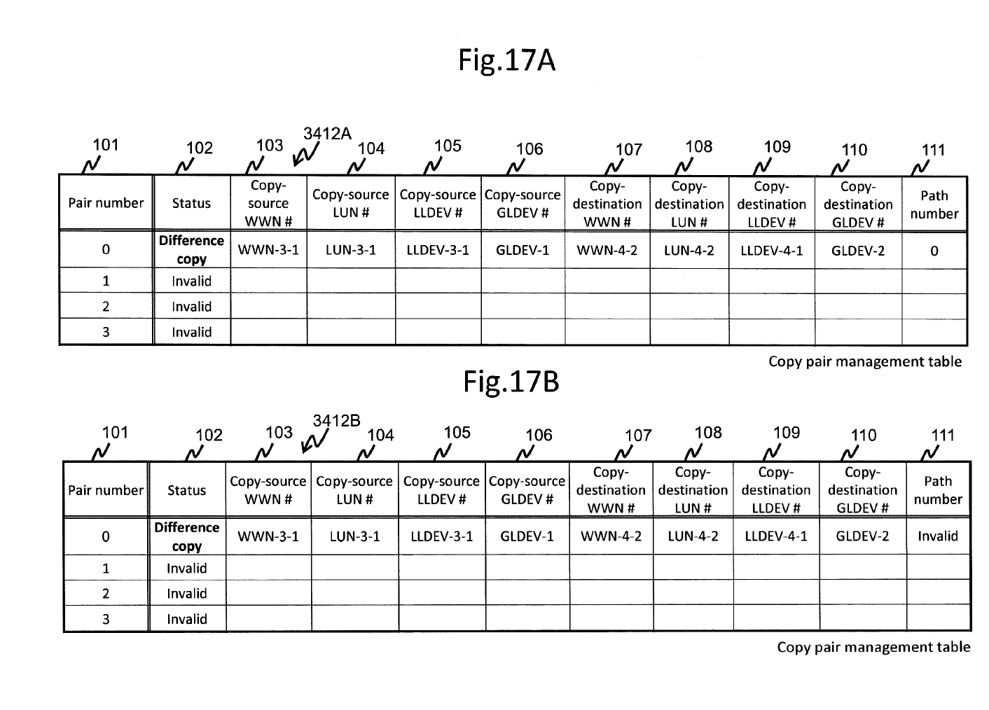

In Step S1304, the storage apparatus #3, upon receiving the notification from the storage apparatus #4 to the effect that the initial copy process has ended, as shown in FIG. 17A, configures the status 102 of the copy pair management table 1312A to “difference copy”, and also sends the data of the bitmap 113 corresponding to the relevant volume copy process of the bitmap management table 3413A shown in FIG. 16A to the storage apparatus #4. Thereafter, the storage apparatus #3 sends the data of the block required by the copy process to the storage apparatus #4 based on the bitmap.

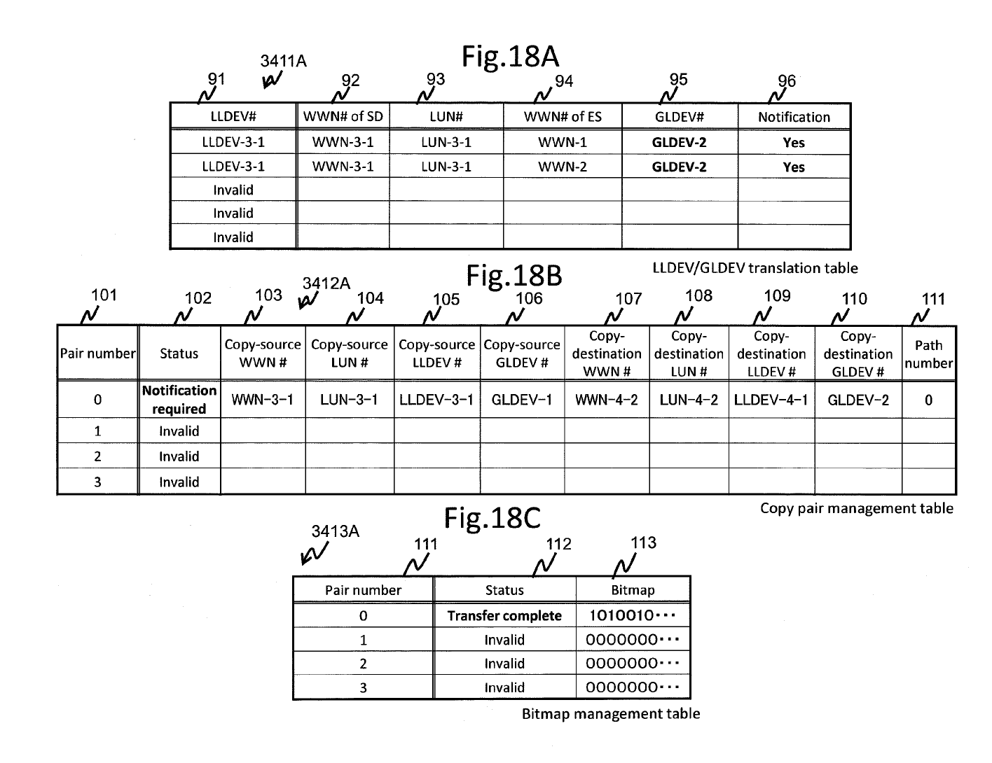

After sending the bitmap data, the storage apparatus #3 configures the status 112 of the bitmap management table 3413A to “transfer complete” as shown in FIG. 18C. Then, as shown in FIG. 18A, the storage apparatus #3 changes the GLDEV #95 of all of the rows in which the LLDEV #91 of the LLDEV/GLDEV translation table 3411A is “LLDEV-3-1” to “GLDEV-2”, configures the notification 96 to “yes”, and as shown in FIG. 18B, configures the status 102 of the row corresponding to the volume copy processing-target copy pair in the copy pair management table 3412A to “notification required”. In accordance with this, the GLDEV path in the storage apparatus #3 is changed, that is, the GLDEV is associated and managed with a new LLDEV subsequent to migration.

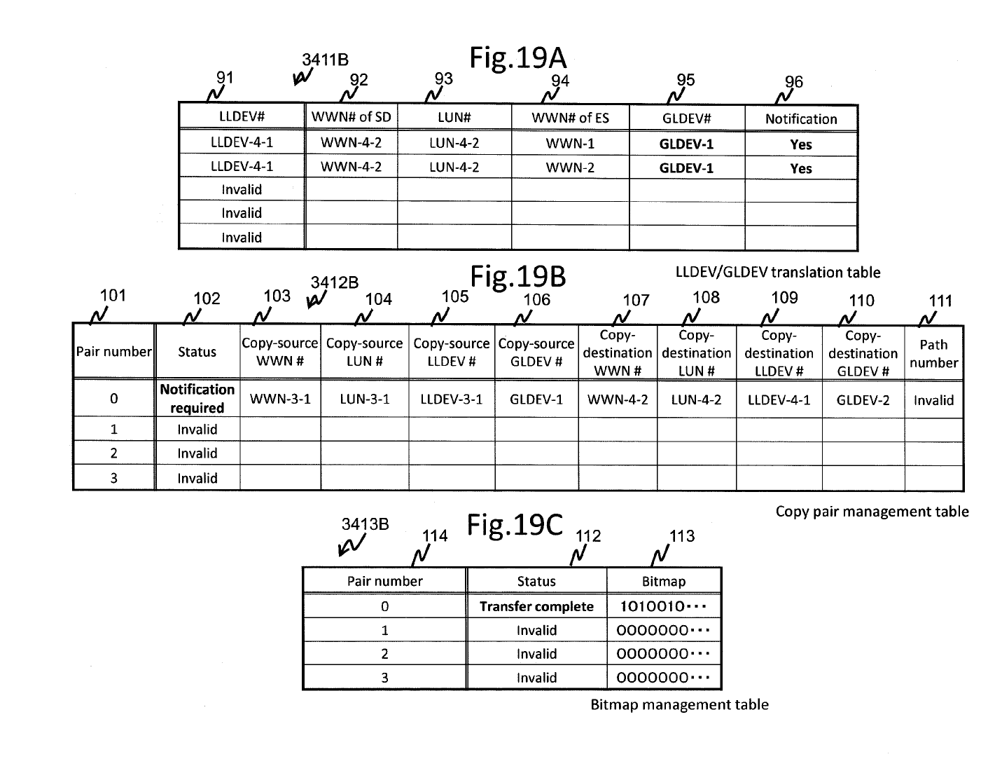

(*) Meanwhile, in Step S1312, the storage apparatus #4 receives the bitmap data. The storage apparatus #4, upon receiving the bitmap data, as shown in FIG. 19C, configures the status 112 of the bitmap management table 3413B to “transfer complete” and updates the bitmap 113 based on the received bitmap data.

After updating the bitmap management table 3413B based on the received bitmap data, the storage apparatus #4, as shown in FIG. 19A, configures the GLDEV #95 of all of the rows in which the LLDEV #91 of the LLDEV/GLDEV translation table 3411B is “LLDEV-4-1”, which is the copy-destination LLDEV, to “GLDEV-1”, which is the copy-source GLDEV, and configures the notification 96 to “yes”. In addition, as shown in FIG. 19B, the storage apparatus #4 configures the status 102 related to the volume copy processing-target copy pair in the copy pair management table 3412B to “notification required”. In accordance with this, the GLDEV path in the storage apparatus #4 is changed, that is, the GLDEV is associated and managed with a new LLDEV subsequent to migration. Thereafter, the storage apparatus #4 consecutively receives block data sent from the storage apparatus #3, and, in addition to storing this data in the corresponding block, configures the bit corresponding to the block storing the data to “0” in the bitmap 113 of the bitmap management table 3413B. An IO command for performing a write with respect to the copy-destination LLDEV could be sent from the edge storage 20 based on an IO request from the host computer 10 at this point in time, but in a case where the block data sent from the storage apparatus #3 is being received consecutively, that is, a case in which the difference copy processing has not ended, the storage apparatus #4 exercises control so that the processing of the IO command sent from the edge storage 20 is not executed, for example, so that the IO command-target data is not written until the difference copy processing has ended. After the difference copy processing has ended, the storage apparatus #4 executes the processing corresponding to the IO command received during the difference copy process.

After all of the copy-source LLDEV data (the initial data and the data updated thereafter) stored in the storage apparatus #3 has been sent to the storage apparatus #4, at an arbitrary point in time, the storage apparatus #3 may delete the volume data of the LLDEV-3-1, which is the copy-source LLDEV.

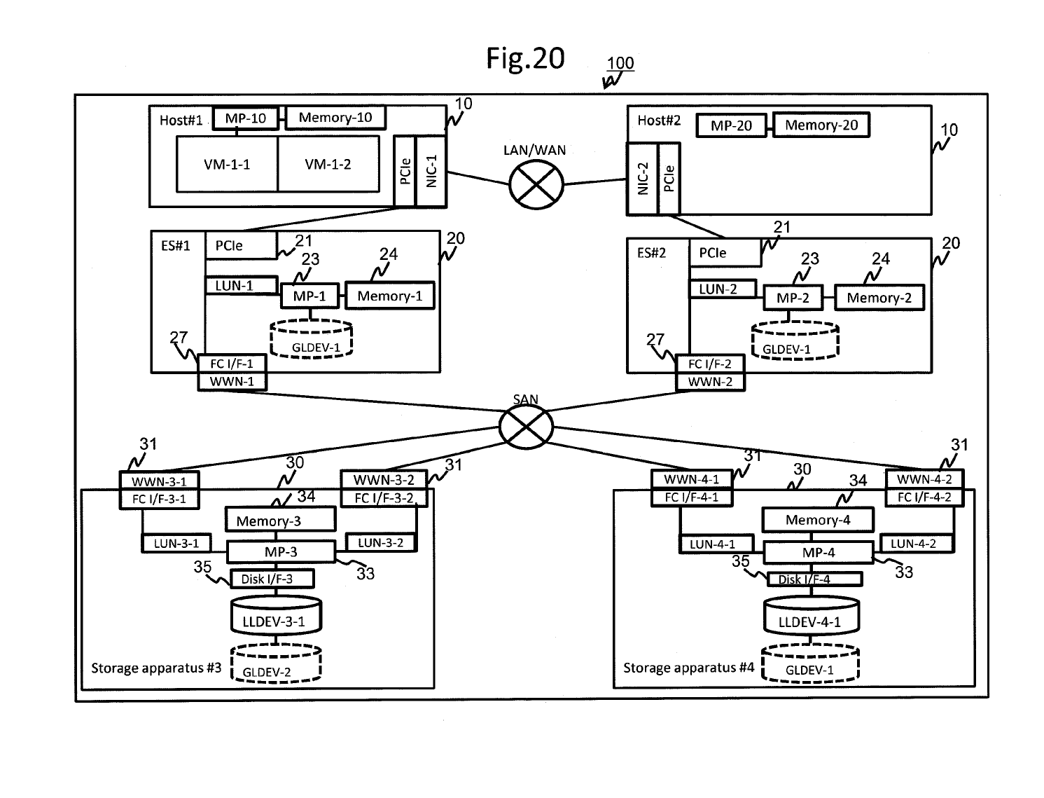

FIG. 20 shows the state of a computer subsystem after a path change in a storage apparatus.

After a path in the storage apparatus 30 has been changed during the difference copy process, as shown in FIG. 20, the GLDEV-2 is associated and managed with the LLDEV-3-1 in the storage apparatus #3, and the GLDEV-1 is associated and managed with the LLDEV-4-1 in the storage apparatus #4. At this point, the storage apparatus #3 and the storage apparatus #4 (either the copy-source storage apparatus or the copy-destination storage apparatus) manage this new corresponding relationship between the LLDEV and the GLDEV in the LLDEV/GLDEV translation tables 3411A and 3411B, respectively, and, in addition, configure the notification 96 to “yes” so as to show that a notification of this change is needed for the edge storage 20, which accesses the LLDEV for which the corresponding relationship has changed. The storage apparatus 30, based on the fact that the notification 96 is “yes” in the LLDEV/GLDEV translation tables 3411A and 3411B, notifies the edge storage 20 of the new corresponding relationship between the LLDEV and the GLDEV at a prescribed time, and changes the corresponding relationship in the edge storage 20, that is, causes a path change to be performed. Thus, LLDEV-GLDEV corresponding relationship can be appropriately changed to the new LLDEV-GLDEV corresponding relationship in the edge storage 20. The prescribed time may be when the storage apparatus 30 has received an IO command from the edge storage 20.

According to the processing described hereinabove, it is possible to reflect write data sent to the copy-source storage apparatus #3 during initial copy processing in the copy-destination LLDEV of the copy-destination storage apparatus #4 without loss in the difference copy process subsequent to the initial copy process.

During the difference copy process, the edge storage 20 may temporarily store an IO command for the copy-source LLDEV, which is performing the difference copy processing, in the CM 241, and may send the IO command to the copy-destination LLDEV thereafter. In accordance with this, for example, the copy-source storage apparatus 30, which receives the IO command from the edge storage 20, may, without accepting the IO command, send the edge storage 20 a response to the effect that it would like the IO command to be transferred to the copy-destination storage apparatus 30, and based on this response, the edge storage 20 may temporarily store this IO command and send it to the copy-destination storage apparatus 30 thereafter.

Next, the processing related to an edge storage 20 path translation will be explained.

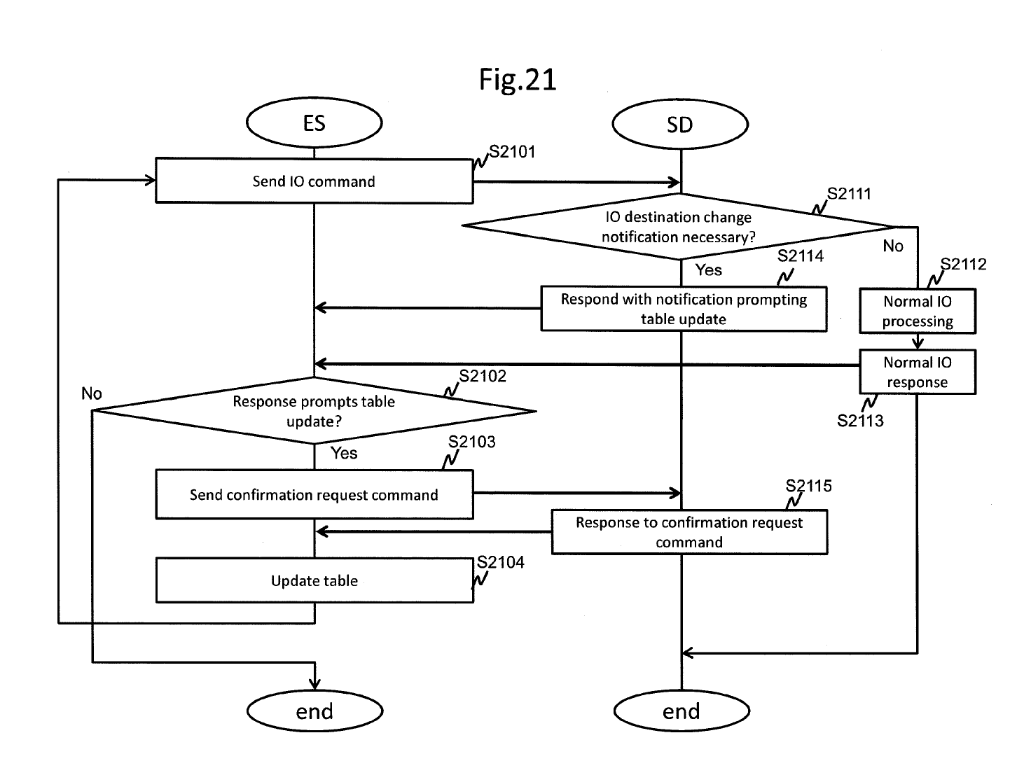

In this example, the process for performing a path translation in the edge storage 20 is realized by being incorporated into the processing for sending and receiving an IO command between the edge storage 20 and the storage apparatus 30. That is, a path translation is performed in each edge storage 20 in accordance with executing the processing for sending and receiving an IO command shown in FIG. 21, which will be explained further below.

FIG. 21 is a flowchart of sending and receiving processing related to the example.

This sending and receiving processing is performed between the edge storage 20, which receives an IO request from the host computer 10 and sends an IO command, and the storage apparatus 30, which is the destination of the IO command.

(*) In Step S2101, the edge storage 20 sends an IO command to the storage apparatus 30 based on an IO request from the host computer 10. Specifically, the edge storage 20 receives an IO request specifying an access-target LUN # from the host computer 10, references the LUN/GLDEV translation table 2411, and identifies the GLDEV # corresponding to the LUN indicated by the LUN #. Next, the edge storage 20 references the GLDEV/internal path translation table 2412, and identifies the LLDEV # corresponding to the identified GLDEV # and the internal path (the WWN # and the LUN #) to the LLDEV. Next, the edge storage 20 sends an IO command specifying the identified LLDEV # and internal path (the WWN # and the LUN #) to the LLDEV to the storage apparatus 30.
(*) In Step S2111, the storage apparatus 30 receives the IO command, and determines whether or not it is necessary to notify the edge storage 20 of the fact that the LLDEV corresponding to the IO command has migrated. Specifically, the storage apparatus 30 references the LLDEV/GLDEV translation table 3411, and determines whether or not the notification 96 in the row corresponding to the WWN of the source edge storage 20, the internal path (that is, the ES-SD path), and the destination LLDEV # specified in the relevant IO command is “yes”. In a case where the result of the determination is that the notification 96 is “yes” (Step S2111: Yes), the storage apparatus 30 advances the processing to Step S2114. Alternatively, in a case where the result of the determination is that the notification 96 is “no” (Step S2111: No), the storage apparatus 30 advances the processing to Step S2112. Managing the notification like this makes it possible to appropriately manage the issuing of a notification to the effect that the LLDEV has migrated.
(*) In Step S2112, the storage apparatus 30 performs IO processing conforming to the IO command, and advances the processing to Step S2113.
(*) In Step S2113, the storage apparatus 30 sends a response to the edge storage 20, which is the source of the IO command, to the effect that the IO processing has ended, and ends the processing.
(*) In Step S2114, the storage apparatus 30 sends a response to the edge storage 20 to the effect that the GLDEV/internal path translation table 2412 should be updated. In this example, the storage apparatus 30 sends a response included in a prescribed area of the response to the IO command to the effect that the GLDEV/internal path translation table 2412 should be updated. Since the IO command is used like this to send a response to the effect that the GLDEV/internal path translation table 2412 should be updated, it is possible to realize the above processing by performing an easy revision to the processing related to the sending and receiving of an existing IO command.
(*) In Step S2102, the edge storage apparatus 20 receives the response to the IO command from the storage apparatus 30, and determines what kind of response has been received. Specifically, the edge storage apparatus 20 determines whether or not the received response is a response, which prompts the updating of the GLDEV/internal path translation table 2412. In a case where the result of the determination is that the response prompts the updating of the GLDEV/internal path translation table 2412 (Step S2102: Yes), the edge storage apparatus 20 advances the processing to Step S2103. Alternatively, in a case where the result of the determination is that the response does not prompt the updating of the GLDEV/internal path translation table 2412, that is, a case in which it is a response to the effect that the IO processing has ended (Step S2102: No), the edge storage 20 ends the processing.
(*) In Step S2103, the edge storage 20 sends a command (a confirmation request command) to the storage apparatus 30 requesting confirmation of the content of the GLDEV change. Specifically, the edge storage 20 references the GLDEV/internal path translation table 2412, acquires the GLDEV # of the GLDEV targeted by the IO command sent in S2101, and the WWN # and the LUN #, which were specified in the IO command, and sends a confirmation request command specifying these numbers to the storage apparatus 30. Thus, since the edge storage 20 sends the GLDEV #, the WWN #, and the LUN # correspondingly managed by the edge storage 20, the latest status of the GLDEV corresponding to this GLDEV # can be appropriately identified by the storage apparatus 30.
(*) In Step S2115, the storage apparatus 30, upon receiving the confirmation request command, identifies the WWN # and the LUN # showing the LLDEV, which is associated with the GLDEV indicated by the GLDEV # in the storage apparatus 30 based on the WWN # of the edge storage 20, which sent the confirmation request command, and the GLDEV #, the WWN #, and the LUN # specified in the confirmation request command. Specifically, the storage apparatus 30 determines whether or not a row corresponding to the GLDEV # of the confirmation request command exists in the LLDEV/GLDEV translation table 3411, and in a case where a row corresponding to the GLDEV # exists, identifies the LLDEV #91, the SD WWN #92, and LUN #93 of this row as the LLDEV #, the WWN #, and the LUN # indicating the LLDEV associated with the GLDEV indicated by the GLDEV #.

Alternatively, in a case where a row corresponding to the GLDEV # of the confirmation request command does not exist, the storage apparatus 30 searches the copy pair management table 3412 for a row in which is stored content corresponding to the combination of the GLDEV #, the WWN #, and the LUN # of the confirmation request command, and in a case where a combination thereof is being stored as information related to the copy source, identifies the combination of the LLDEV #, the WWN #, and the LUN #, which are configured as information related to the copy destination, as the LLDEV #, the WWN #, and the LUN # indicating the LLDEV, which is associated with the GLDEV indicated by the GLDEV #, and, alternatively, in a case where the combination thereof is being stored as information related to the copy destination, identifies the combination of the LLDEV #, the WWN #, and the LUN #, which are configured as information related to the copy source, as the LLDEV #, the WWN #, and the LUN # indicating the LLDEV, which is associated with the GLDEV indicated by the GLDEV #. Next, the storage apparatus 30 sends the identified LLDEV #, WWN #, and LUN # to the edge storage 20 as a response to the confirmation request command.

Thereafter, the storage apparatus 30 sets the notification 96 to “no” in the corresponding row (that is, the row corresponding to the WWN of the IO command-source edge storage 20, and the WWN # and the LUN # specified in the IO command) of the LLDEV/GLDEV translation table 3411. In a case where the notification 96 is “yes” in a row corresponding to an IO command-target LLDEV # other than the corresponding row of the LLDEV/GLDEV translation table 3411, the storage apparatus 30 also configures the status 102 to “notification required” in the corresponding row (the row in which the IO command-target LLDEV # is either the copy-source LLDEV # or the copy-destination LLDEV #) of the copy pair management table 3412A. In a case where the notification 96 is not “yes” in the row corresponding to the IO command-target LLDEV # other than the corresponding row of the LLDEV/GLDEV translation table 3411, the storage apparatus 30 configures the status 102 to “deletable” in the corresponding row (the row in which the IO command-target LLDEV # is either the copy-source LLDEV # or the copy-destination LLDEV #) of the copy pair management table 3412A.

In Step S2104, the edge storage 20 updates the GLDEV/internal path translation table 2412 based on the response from the storage apparatus 30, and moves the processing to Step S2101. This makes it possible to reflect the corresponding relationship between the GLDEV managed by the storage apparatus 30 and the LLDEV in the corresponding relationship between the GLDEV corresponding to the IO request and the LLDEV managed by the edge storage 20. In the subsequent Step S2101, since the edge storage 20 uses the post-update GLDEV/internal path translation table 2412 to create an IO command corresponding to the IO request, which had as its basis the IO command of the previous Step S2101, the LLDEV currently associated with the GLDEV can be appropriately accessed. In this example, since the processing for updating the GLDEV/internal path translation table 2412 is performed as the result of an IO request from the edge storage 20, it is possible to prevent the unnecessary updating of the GLDEV/internal path translation table 2412, as well as wasteful communications related thereto.

Next, a specific example of a process for performing an edge storage 20 path translation will be explained for a computer subsystem 100 in the state shown in FIG. 20, that is, a state subsequent to a path having been changed in the volume copy process. In the storage apparatus #3 and the storage apparatus #4 at the point in time of this state, as shown in FIGS. 18A and 19A, the GLDEV-1 is associated and managed with the LLDEV-4-1, and the GLDEV-2 is associated and managed with the LLDEV-3-1. Alternatively, in the edge storage #1 and the edge storage #2, as shown in FIGS. 7A and 7B, the LLDEV-3-1 is associated with the GLDEV-1, and the LLDEV-4-1 is associated with the GLDEV-2 as before.

The processing of the computer subsystem 100 when cases such as those described below occur after the point in time of this state will be explained hereinbelow.

At this point in time, as path information for the LLDEV related to a volume copy, which is not reflected in the edge storage #1 and the edge storage #2, there is information on the ES-SD paths (second access information) from the edge storages #1 and #2 to the LLDEV-3-1, which is the copy source of a volume copy, in the storage apparatus #3 as shown in FIG. 18A, and there is information on the ES-SD paths (second access information) from the edge storages #1 and #2 to the LLDEV-4-1, which is the copy destination of the volume copy, in the storage apparatus #4 as shown in FIG. 19A. The GLDEV/internal path translation tables 2412A and 2412B shown in FIGS. 7A and 7B are stored in the edge storages #1 and #2. The path information of the GLDEV/internal path translation tables 2412A and 2412B shown in FIGS. 7A and 7B correspond to first access information.

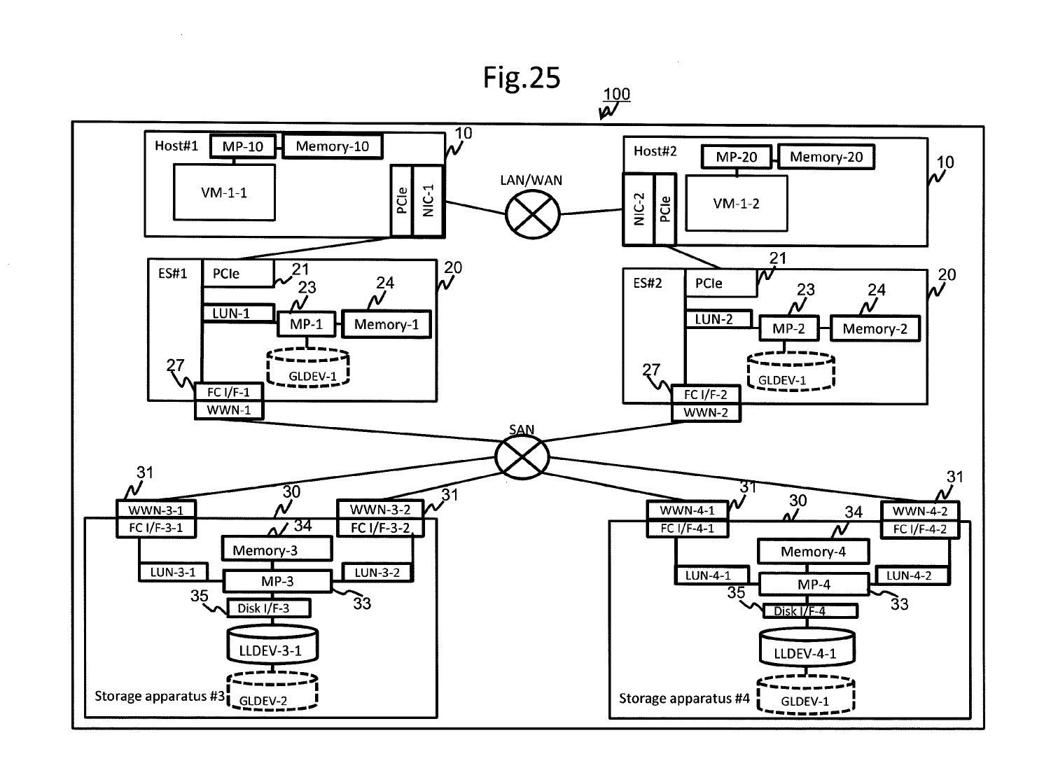

(1) A case in which an IO request regarding the “LUN-1” is sent to the edge storage #1 by an application being executed on a VM-1-1, which is running on the host #1.
(2) After the (1), a case in which processing is performed with respect to the IO request regarding the “LUN-1” by the application being executed on the VM-1-1, which is running on the host #1.
(3) After the (2), a case in which, after a VM-1-2, which is running on the host #1, has been migrated to the host #2 as shown in FIG. 25, an IO request regarding the “LUN-2” is sent to the edge storage #2 by an application being executed by the VM-1-2, which is running on the host #2.
(4) After the (3), a case in which processing is performed with respect to the IO request regarding the “LUN-2” by the application being executed on the VM-1-2, which is running on the host #2.

First, the processing by the computer subsystem 100 in (1) will be explained by referring to FIG. 21 as needed.

When an IO request regarding the “LUN-1” is sent to the edge storage #1 from the host #1, in Step S2101, the edge storage #1 receives the IO request specifying the “LUN-1”, references the LUN/GLDEV translation table 2411A shown in FIG. 6A, and identifies the “GLDEV-1”. In addition, the edge storage #1 references the GLDEV/internal path translation table 2412A shown in FIG. 7A, and identifies the “LLDEV-3-1” corresponding to the “GLDEV-1”, and the internal path (“WWN-3-1” and “LUN-3-1”) to the LLDEV. Then, the edge storage #1 sends the IO command specifying the “LLDEV-3-1”, the “WWN-3-1”, and the “LUN-3-1” to the storage apparatus #3.

In Step S2111, the storage apparatus #3 receives the IO command, references the LLDEV/GLDEV translation table 3411A shown in FIG. 18A, and determines whether or not the notification 96 is “yes” for the row corresponding to the WWN (“WWN-1”) of the edge storage #1 specified by the relevant IO command, and the “WWN-3-1”, the “LUN-3-1”, and the “LLDEV-3-1”. As shown in FIG. 18A, since the notification 96 is “yes” (Step S211: Yes), the storage apparatus #3 responds to the edge storage #1 to the effect that the GLDEV/internal path translation table 2412A should be updated (Step S2114).

When the edge storage #1 receives the response from the storage apparatus #3, since the response prompts the updating of the GLDEV/internal path translation table 2412A (Step S2102: Yes), the edge storage #1 references the GLDEV/internal path translation table 2412A shown in FIG. 7A, acquires the “GLDEV-1”, which is the GLDEV targeted by the IO command sent in Step S2101, and the “LLDEV-3-1”, the “WWN-3-1”, and the “LUN-3-1” specified in the IO command, and sends a confirmation request command specifying these elements to the storage apparatus #3 (S2103).

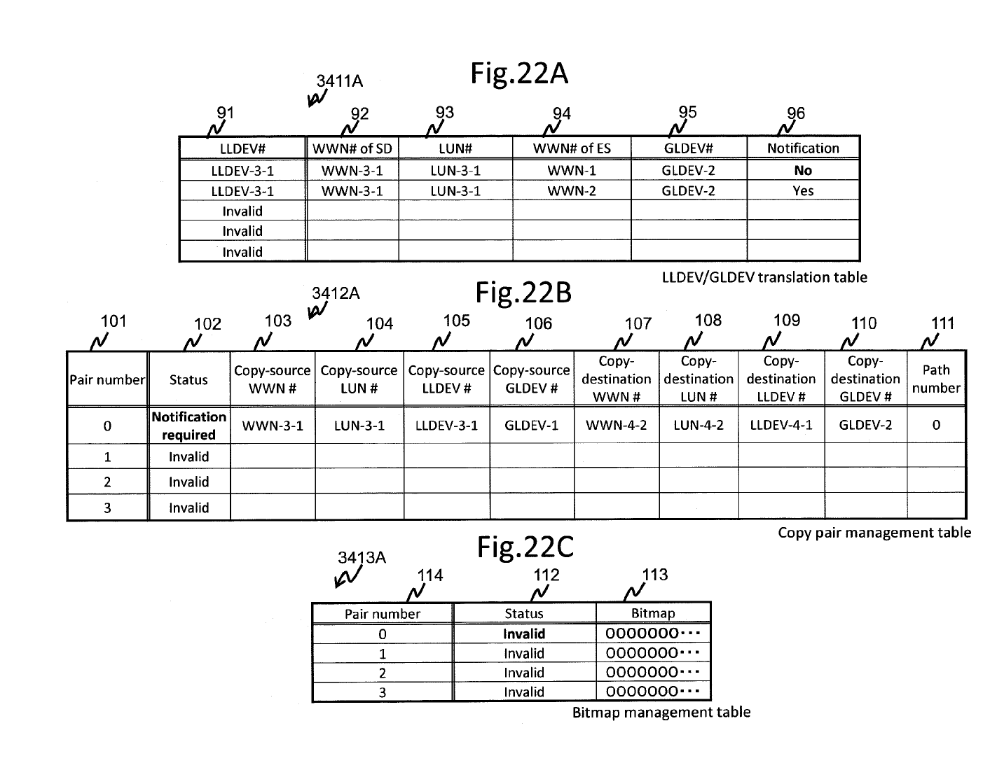

In Step S2115, the storage apparatus #3 receives the confirmation request command and the “GLDEV-1”, the “LLDEV-3-1”, the “WWN-3-1”, and the “LUN-3-1” specified in the confirmation request command. Next, upon referencing the LLDEV/GLDEV translation table 3411A shown in FIG. 18A and making a determination as to whether or not there exists a row corresponding to the “WWN-1” of the edge storage #1, which is the source of the confirmation request command, and the “GLDEV-1”, the “LLDEV-3-1”, the “WWN-3-1”, and the “LUN-3-1” specified by the confirmation request command, the storage apparatus #3 learns that there is no corresponding row. Consequently, the storage apparatus #3 references the copy pair management table 3412A shown in FIG. 18B and searches for a row in which the combination of “WWN-3-1”, “LUN-3-1”, and “GLDEV-1” is stored as either the copy-source information or the copy-destination information. At this point, the row in which the pair #101 is “0” is found. Next, since the combination of the “WWN-3-1”, the “LUN-3-1”, and the “GLDEV-1” in the found row is stored as the copy-source information, the storage apparatus #3 acquires the “WWN-4-2”, “LUN-4-2”, and “LLDEV-4-1” stored as the copy-destination information, and sends the edge storage #1 a response to the confirmation request command comprising the “WWN-4-2”, “LUN-4-2”, and “LLDEV-4-1”. Subsequent to the response, the storage apparatus #3 configures the notification 96 to “no” in the row in which the SD WWN #92 of the LLDEV/GLDEV translation table 3411A is “WWN-3-1”, the LUN #93 is “LUN-3-1”, and the ES WWN #94 is “WWN-1” as shown in FIG. 22A. Since “yes” is stored in the notification 96 of a different row of the LLDEV/GLDEV translation table 3411A in which the LLDEV #91 is also “LLDEV-3-1”, as shown in FIG. 22B, the storage apparatus #3 configures the status 102 to “notification required” in the row in which either the copy-source LLDEV #105 or the copy-destination LLDEV #109 of the copy pair management table 3412A is “LLDEV-3-1”.

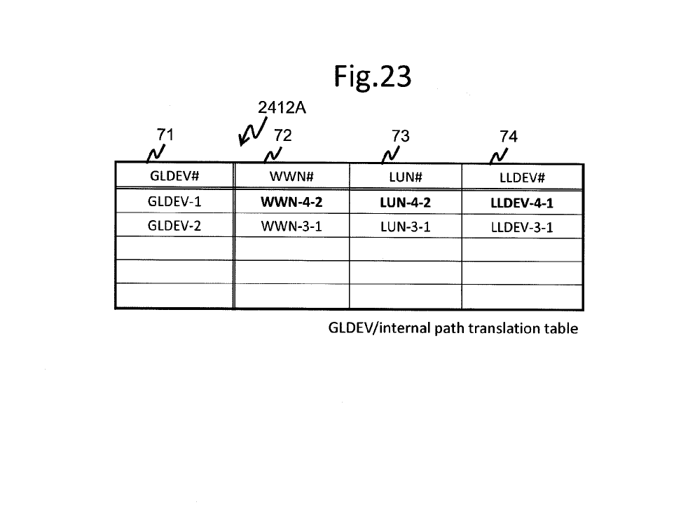

The edge storage #1, upon receiving the response to the confirmation request command from the storage apparatus #3, updates the GLDEV/internal path translation table 2412A based on the contents (“WWN-4-2”, “LUN-4-2”, and “LLDEV-4-1”) of the response to the confirmation request command (Step S2104). That is, the edge storage #1, as shown in FIG. 23, updates the WWN #72, the LUN #73, and the LLDEV #74 in the row in which the GLDEV #71 of the GLDEV/internal path translation table 2412A is “GLDEV-1” to “WWN-4-2”, “LUN-4-2”, and “LLDEV-4-1”.

This makes it possible for the edge storage #1 to appropriately send an IO command with respect to an IO request regarding “LUN-1” to the “LLDEV-4-1” of the storage apparatus #4, which is the migration-destination LLDEV of the volume data corresponding to the “LUN-1”. Thereafter, the edge storage #1 uses the post-update GLDEV/internal path translation table 2412A to send an IO command with respect to the IO request received in Step S2101 (Step S2101). This processing will be explained in (2) below.

In a case where the difference copy processing of the volume copy process related to the copy pair for which the copy pair number is “0” has ended, since all the bits of the bitmap 113 become “0” as shown in FIG. 22C, the storage apparatus #3 configures the status 112 to “invalid” in the row in which the copy pair number of the bitmap management table 3413A is “0”.

Next, the processing by the computer subsystem 100 in (2) will be explained by referring to FIG. 21 as needed.

The edge storage #1, with respect to an IO request regarding the “LUN-1”, references the LUN/GLDEV translation table 2411A shown in FIG. 6A, identifies the “GLDEV-1”, and also references the GLDEV/internal path translation table 2412A shown in FIG. 23 and identifies the “LLDEV-4-1” corresponding to the “GLDEV-1”, and the internal path to the LLDEV (“WWN-4-2”, “LUN-4-2”). Then the edge storage #1 sends an IO command specifying the “LLDEV-4-1”, the “WWN-4-2”, and the “LUN-4-2” to the storage apparatus #4.

In Step S2111, the storage apparatus #4 receives the IO command, references the LLDEV/GLDEV translation table 3411B shown in FIG. 19A, and determines whether or not the notification 96 is “yes” in the row corresponding to the WWN (“WWN-1”) of the edge storage #1 specified in the relevant IO command, and the “WWN-4-2”, the “LUN-4-2”, and “LLDEV-4-1”. As shown in FIG. 19A, since the notification 96 is “yes” (Step S2111: Yes), the storage apparatus #4 issues a response to the edge storage #1 to the effect that the GLDEV/internal path translation table 2412A should be updated (Step S2114).

When the edge storage #1 receives the response from the storage apparatus #4, since the response prompts the updating of the GLDEV/internal path translation table 2412A (Step S2102: Yes), the edge storage #1 references the GLDEV/internal path translation table 2412A shown in FIG. 23, acquires the “GLDEV-1”, which is the GLDEV targeted by the IO command sent in S2101, and the “LLDEV-4-1”, the “WWN-4-2”, and the “LUN-4-2”, which are specified in the IO command, and sends a confirmation request command specifying these elements to the storage apparatus #4 (S2103).

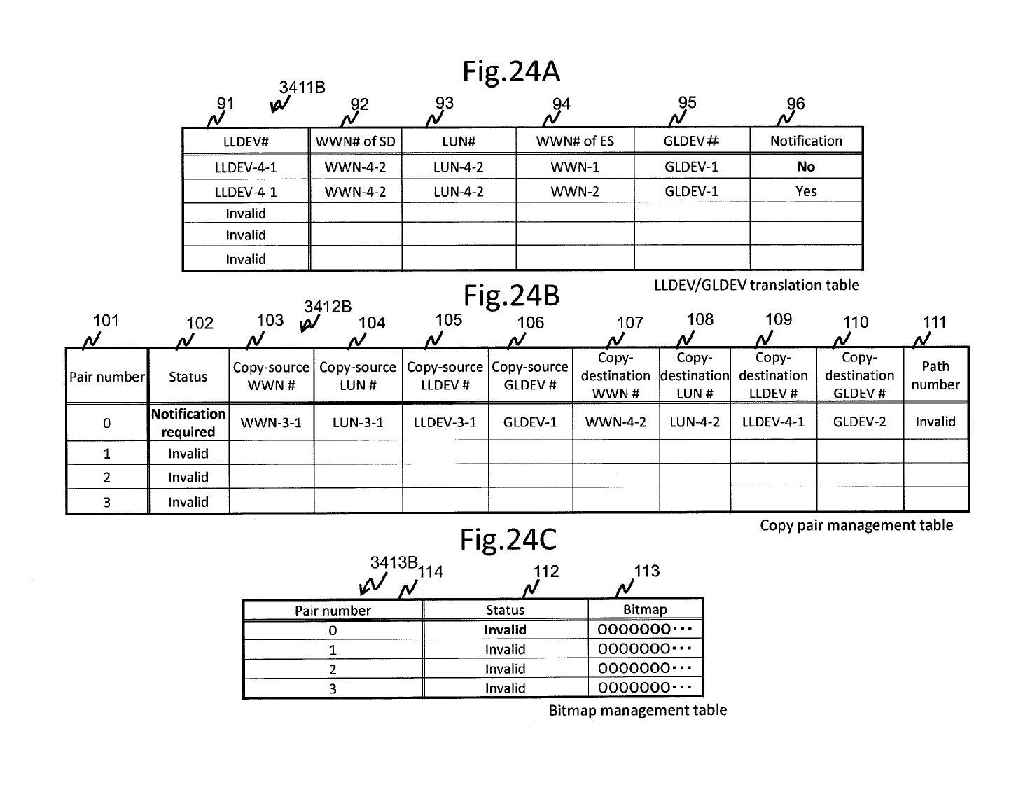

In Step S2115, the storage apparatus #4 receives the confirmation request command and the “GLDEV-1”, the “LLDEV-4-1”, the “WWN-4-2”, and the “LUN-4-2” specified in the confirmation request command. Next, upon referencing the LLDEV/GLDEV translation table 3411B shown in FIG. 19A and making a determination as to whether or not there is a row corresponding to the “WWN-1” of the edge storage #1, which is the source of the confirmation request command, and the “GLDEV-1”, the “LLDEV-4-1”, the “WWN-4-2”, and the “LUN-4-2”, which are specified in the confirmation request command, the storage apparatus #4 learns that a corresponding row exists. Consequently, the storage apparatus #4 sends a confirmation request command response comprising the “WWN-4-2”, the “LUN-4-2”, and the “LLDEV-4-1” to the edge storage #1. Subsequent to the response, the storage apparatus #4 configures “No” in the notification 96 for the row in which the SD WWN #92 is “WWN-4-2”, the LUN #93 is “LUN-4-2”, and the ES WWN #94 is “WWN-1” in the LLDEV/GLDEV translation table 3411B as shown in FIG. 24A. Also, since “yes” is stored in the notification 96 of a different row of the LLDEV/GLDEV translation table 3411B in which the LLDEV #91 is also “LLDEV-4-1”, as shown in FIG. 24B, the storage apparatus #4 configures the status 102 to “notification required” in the row in which either the copy-source LLDEV #105 or the copy-destination LLDEV #109 of the copy pair management table 3412B is “LLDEV-4-1”.

The edge storage #1, upon receiving the response to the confirmation request command from the storage apparatus #4, updates the GLDEV/internal path translation table 2412A based on the contents of the response to the confirmation request command (the “WWN-4-2”, the “LUN-4-2”, and the “LLDEV-4-1”) (Step S2104). That is, the edge storage #1, as shown in FIG. 23, updates the SD WWN #72, the LUN #73, and the LLDEV #74 in the row of the GLDEV/internal path translation table 2412A in which the GLDEV #71 is “GLDEV-1” to “WWN-4-2”, “LUN-4-2”, and “LLDEV-4-1”. In this example, the contents of the GLDEV/internal path translation table 2412A do not change before and after the update.

This makes it possible for the edge storage #1 to appropriately send an IO command with respect to an IO request regarding the “LUN-1” to the storage apparatus #4 LLDEV-4-1, which is the LLDEV for which volume data corresponding to the “LUN-1” was migrated in accordance with the volume copy process. Thereafter, the edge storage #1 uses the post-update GLDEV/internal path translation table 2412A to send an IO command with respect to the IO request received in Step S2101 (Step S2101), and processing corresponding to the IO command is executed in the storage apparatus #4 (Step S2112).

Since all the bits in the bitmap 113 transition to “0” as shown in FIG. 24C in a case where difference copy processing in the volume copy process related to a copy pair for which the copy pair number is “0” has ended, the storage apparatus #4 configures the status 112 to “invalid” for the row of the bitmap management table 3413B in which the copy pair number is “0”.

Next, the processing by the computer subsystem 100 in the (3) will be explained by referring to FIG. 21 as needed. This processing will be explained by assuming that, subsequent to the (2), the VM-1-2 running on the host #1 is migrated to and runs on the host #2 as shown in FIG. 25, and the same application is executed.

When an IO request regarding the “LUN-2” is sent to the edge storage #2 by the application being executing on the VM-1-2 running on the host #2, in Step S2101, the edge storage #2 receives the IO request specifying the “LUN-2”, references the LUN/GLDEV translation table 2411B shown in FIG. 6B, and identifies the “GLDEV-1”. In addition, the edge storage #2 references the GLDEV/internal path translation table 2412B shown in FIG. 7B, and identifies the “LLDEV-3-1”, which corresponds to the “GLDEV-1”, and the internal path (the “WWN-3-1” and the “LUN-3-1”) to the LLDEV. Then, the edge storage #2 sends an IO command specifying the “LLDEV-3-1”, the “WWN-3-1”, and the “LUN-3-1” to the storage apparatus #3.

In Step S2111, the storage apparatus #3 receives the IO command, references the LLDEV/GLDEV translation table 3411A shown in FIG. 22A, and determines whether or not the notification 96 is “yes” in the row corresponding to the edge storage #2 WWN (“WWN-2”) specified in the relevant IO command, and the “WWN-3-1”, the “LUN-3-1”, and “LLDEV-3-1”. Since the notification 96 at this point is “yes” as shown in FIG. 22A (Step S2111: Yes), the storage apparatus #3 issues a response to the edge storage #2 to the effect that the GLDEV/internal path translation table 2412B should be updated (Step S2114).

When the edge storage #2 receives the response from the storage apparatus #3, since the response prompts the updating of the GLDEV/internal path translation table 2412B (Step S2102: Yes), the edge storage #2 references the GLDEV/internal path translation table 2412B shown in FIG. 7B, acquires the “GLDEV-1”, which is the GLDEV targeted by the IO command sent in Step S2101, and the “LLDEV-3-1”, the “WWN-3-1”, and the “LUN-3-1”, which are specified in the IO command, and sends a confirmation request command specifying these elements to the storage apparatus #3 (S2103).

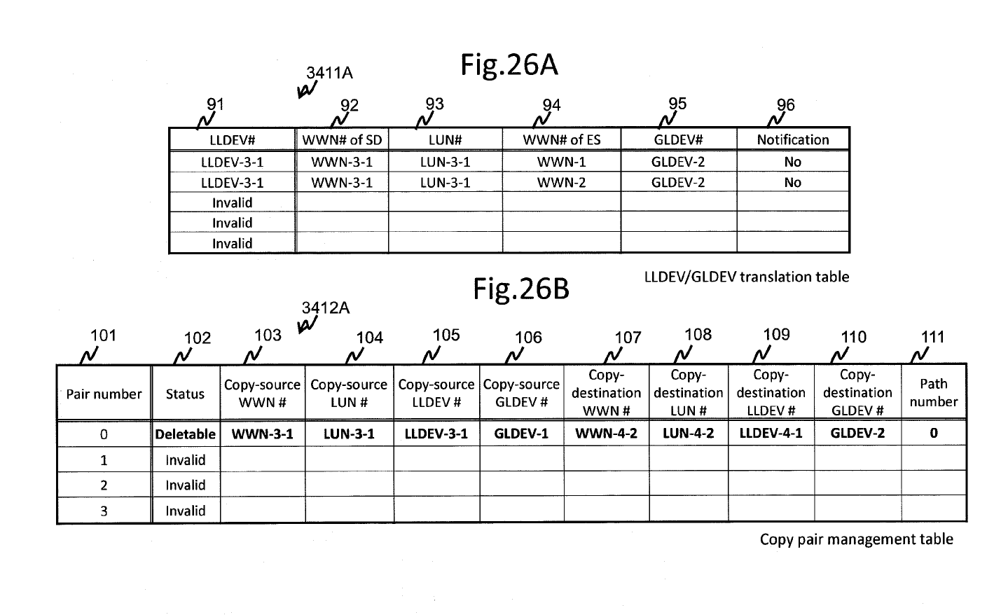

In Step S2114, the storage apparatus #3 receives the confirmation request command, and the “GLDEV-1”, the “LLDEV-3-1”, the “WWN-3-1”, and the “LUN-3-1” specified in the confirmation request command. Next, upon referencing the LLDEV/GLDEV translation table 3411A shown in FIG. 22A and making a determination as to whether or not there exists a row corresponding to the “WWN-2” of the edge storage #2, which is the source of the confirmation request command, and the “GLDEV-1”, the “LLDEV-3-1”, the “WWN-3-1”, and the “LUN-3-1”, which are specified in the confirmation request command, the storage apparatus #3 learns that there is no corresponding row. Consequently, the storage apparatus #3 references the copy pair management table 3412A shown in FIG. 22B, and searches for a row in which the combination of “WWN-3-1”, “LUN-3-1”, and “GLDEV-1” is stored as either the copy-source information or the copy-destination information. At this point, the row in which the pair #101 is “0” is found. Next, since the combination of the “WWN-3-1”, the “LUN-3-1”, and the “GLDEV-1” in the found row is stored as the copy-source information, the storage apparatus #3 acquires the “WWN-4-2”, the “LUN-4-2”, and the “LLDEV-4-1” stored as the copy-destination information, and sends the edge storage #1 a response to the confirmation request command comprising the “WWN-4-2”, the “LUN-4-2”, and the “LLDEV-4-1”. Subsequent to the response, the storage apparatus #3 configures the notification 96 to “no” in the row of the LLDEV/GLDEV translation table 3411A in which the SD WWN #92 is “WWN-3-1”, the LUN #93 is “LUN-3-1”, and the ES WWN #94 is “WWN-2” as shown in FIG. 26A. Since “yes” is not stored in the notification 96 of a different row of the LLDEV/GLDEV translation table 3411A in which the LLDEV #91 is also “LLDEV-3-1”, as shown in FIG. 26B, the storage apparatus #3 configures the status 102 to “deletable” for the row in which either the copy-source LLDEV #105 or the copy-destination LLDEV #109 of the copy pair management table 3412A is “LLDEV-3-1”.

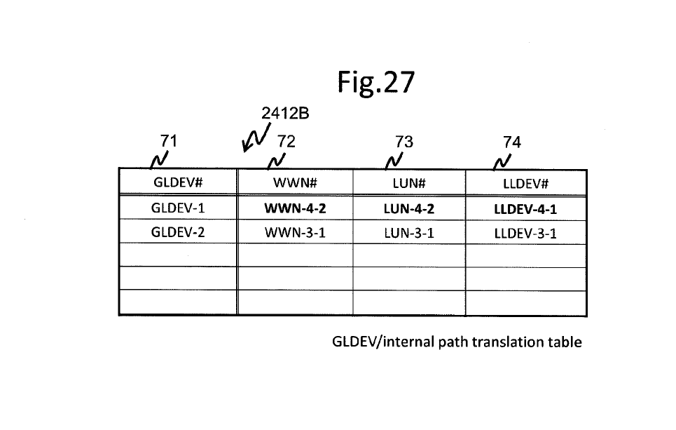

The edge storage #2, upon receiving the response to the confirmation request command from the storage apparatus #3, updates the GLDEV/internal path translation table 2412B based on the contents (“WWN-4-2”, “LUN-4-2”, and “LLDEV-4-1”) of the response to the confirmation request command (Step S2104). That is, the edge storage #2, as shown in FIG. 27, updates the WWN #72, the LUN #73, and the LLDEV #74 in the row in which the GLDEV #71 of the GLDEV/internal path translation table 2412B is “GLDEV-1” to “WWN-4-2”, “LUN-4-2”, and “LLDEV-4-1”.

This makes it possible for the edge storage #2 to appropriately send an IO command with respect to an IO request regarding “LUN-2” to the storage apparatus #4 “LLDEV-4-1”, which is the migration-destination LLDEV of the volume data corresponding to the “LUN-2”. Thereafter, the edge storage #2 uses the post-update GLDEV/internal path translation table 2412B to send an IO command with respect to the IO request received in Step S2101 (Step S2101). This processing will be explained in (4) below.

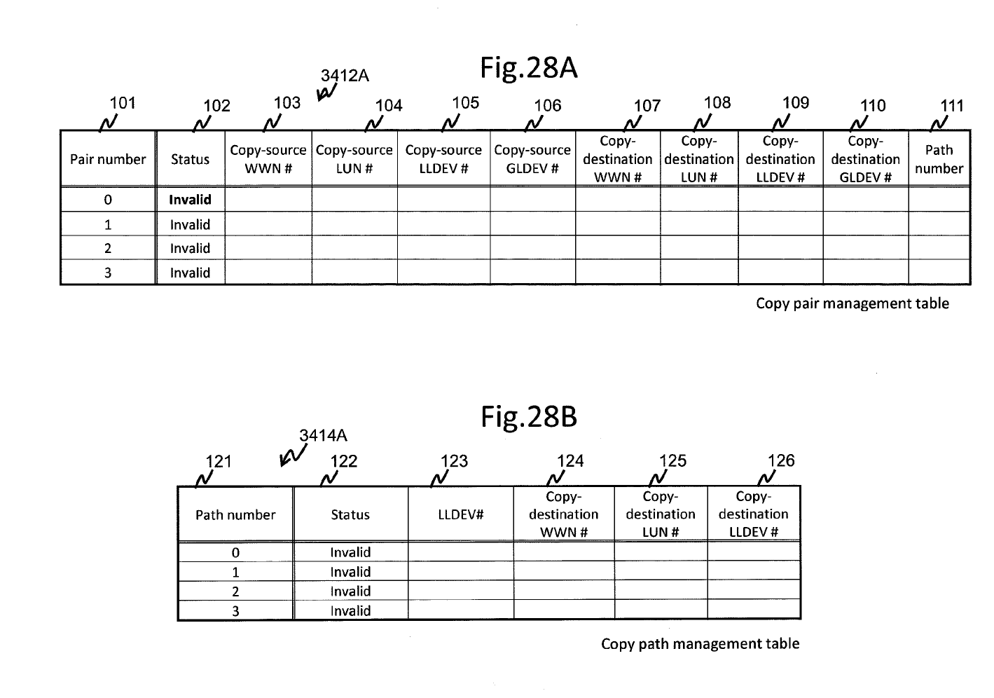

Subsequent to the processing of the (3), as shown in FIG. 28A, the storage apparatus #3 deletes the row for which the pair number “0” of the copy pair management table 3412A in which the status 102 is “deletable”. Based on the “0” of the path number 111 in the row, which was deleted from the copy pair management table 3412A, the storage apparatus #3 also deletes the row of the copy path management table 3414A for which the path number 121 is “0” as shown in FIG. 28B.

Next, the processing by the computer subsystem 100 in the (4) will be explained by referring to FIG. 21 as needed.

The edge storage #2 references the LUN/GLDEV translation table 2411B shown in FIG. 6B with respect to an IO request regarding the “LUN-2”, identifies the “GLDEV-1”, and, in addition, references the GLDEV/internal path translation table 2412B shown in FIG. 27 and identifies the “LLDEV-4-1” corresponding to the “GLDEV-1”, and the internal path (“WWN-4-2” and “LUN-4-2”) to the LLDEV. Then, the edge storage #2 sends an IO command specifying the “LLDEV-4-1”, the “WWN-4-2”, and the “LUN-4-2” to the storage apparatus #4.

In Step S2111, the storage apparatus #4 receives the IO command, references the LLDEV/GLDEV translation table 3411B shown in FIG. 24A, and determines whether or not the notification 96 is “yes” for the row corresponding to the edge storage #2 WWN (“WWN-2”), which is specified by the relevant IO command, and the “WWN-4-2”, the “LUN-4-2”, and the “LLDEV-4-1”. As shown in FIG. 24A, since the notification 96 is “yes” at this point (Step S2111: Yes), the storage apparatus #4 issues a response to the edge storage #2 to the effect that the GLDEV/internal path translation table 2412B should be updated (Step S2114).

When the edge storage #2 receives the response from the storage apparatus #4, since the response prompts the updating of the GLDEV/internal path translation table 2412B (Step S2102: Yes), the edge storage #2 references the GLDEV/internal path translation table 2412B shown in FIG. 27, acquires the “GLDEV-1”, which is the GLDEV targeted by the IO command sent in Step S2101, and the “LLDEV-4-1”, the “WWN-4-2”, and the “LUN-4-2” specified by the IO command, and sends a confirmation request command specifying these elements to the storage apparatus #4 (S2103).

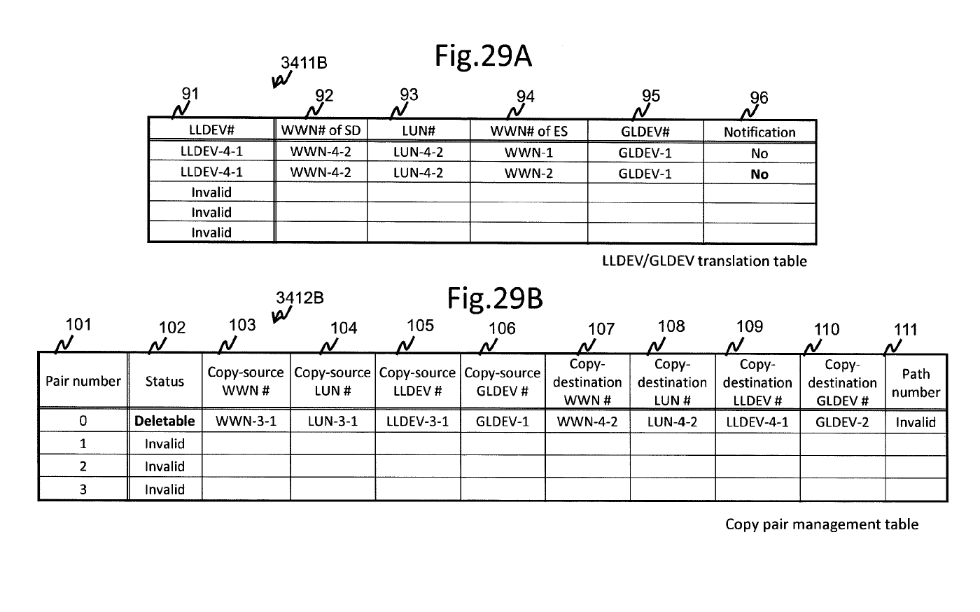

In Step S2114, the storage apparatus #4 receives confirmation request command, and the “GLDEV-1”, the “LLDEV-4-1”, the “WWN-4-2”, and the “LUN-4-2” specified in the confirmation request command. Next, upon referencing the LLDEV/GLDEV translation table 3411B shown in FIG. 24A, and making a determination as to whether or not there exists a row corresponding to the “WWN-2” of the edge storage #2, which is the source of the confirmation request command, and the “GLDEV-1”, the “LLDEV-4-1”, the “WWN-4-2”, and the “LUN-4-2” specified by the confirmation request command, the storage apparatus #4 learns that there is a corresponding row. Consequently, the storage apparatus #4 sends the edge storage #2 a response to the confirmation request command comprising the “WWN-4-2”, the “LUN-4-2”, and “LLDEV-4-1”. Subsequent to the response, the storage apparatus #4 configures the notification 96 to “no” in the row in which the SD WWN #92 of the LLDEV/GLDEV translation table 3411B is “WWN-4-2”, the LUN #93 is “LUN-4-2”, and the ES WWN #94 is “WWN-1” as shown in FIG. 29A. Since “yes” is not stored in the notification 96 of a different row of the LLDEV/GLDEV translation table 3411B in which the LLDEV #91 is also “LLDEV-4-1”, as shown in FIG. 29B, the storage apparatus #4 configures the status 102 to “deletable” in the row in which either the copy-source LLDEV #105 or the copy-destination LLDEV #109 of the copy pair management table 3412B is “LLDEV-4-1”.

The edge storage #2, upon receiving the response to the confirmation request command from the storage apparatus #4 (Step S2104), updates the GLDEV/internal path translation table 2412B based on the contents (“WWN-4-2”, “LUN-4-2”, and “LLDEV-4-1”) of the response to the confirmation request command (Step S2105). That is, the edge storage #2, as shown in FIG. 27, updates the SD WWN #72, the LUN #73, and the LLDEV #74 in the row in which the GLDEV #71 of the GLDEV/internal path translation table 2412B is “GLDEV-1” to “WWN-4-2”, “LUN-4-2”, and “LLDEV-4-1”. In this example, the contents of the GLDEV/internal path translation table 2412B do not change before and after the update.

This makes it possible for the edge storage #2 to appropriately send an IO command with respect to an IO request regarding “LUN-2” to the storage apparatus #4 “LLDEV-4-1”, which is the LLDEV to which the volume data corresponding to the “LUN-2” was migrated in accordance with the volume copy process. Thereafter, the edge storage #2 uses the post-update GLDEV/internal path translation table 2412B to send an IO command with respect to the IO request received in Step S2101 (Step S2101), and processing corresponding to the IO command is executed by the storage apparatus #4 (Step S2112).

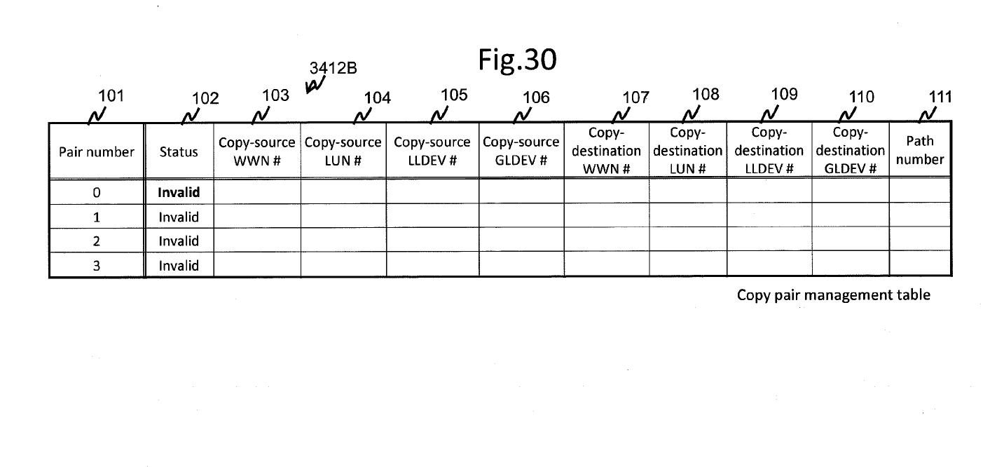

Subsequent to the processing of the (4), as shown in FIG. 30, the storage apparatus #4 deletes the row for which the pair number is “0” of the copy pair management table 3412B in which the status 102 is “deletable”.

As explained hereinabove, according to this example, in a case where the corresponding relationship between its own LLDEV and the GLDEV has changed, the storage apparatus 30 can prompt the edge storage 20, which is managing the ES-SD path, to update the corresponding relationship of the LLDEV and the GLDEV.

The edge storage 20 can send information about the corresponding relationship between the LLDEV and the GLDEV, which it itself is managing, to the storage apparatus 30, and can manage the latest corresponding relationship by having the storage apparatus 30 send information about the latest corresponding relationship between the LLDEV and the GLDEV.

The host computer 10 need not change an IO request even when the corresponding relationship between the GLDEV and the LLDEV has changed, and need not suspend an IO request even while the corresponding relationship between the GLDEV and the LLDEV is in the process of being changed. That is, the host computer 10 can perform an IO request without being conscious of the fact that a volume copy process is being performed or has been performed. Thus, path substitution processing can be performed without suspending an application, which is to perform the IO request being executed by the host computer 10. In addition, since path substitution software does not have to the installed in the host computer 10, path substitution processing can be performed without relying on the host computer 10 OS.

Examples of the present invention have been explained hereinabove, but it goes without saying that the present invention is not limited to the above examples, and that various changes are possible without departing from the gist thereof.

For example, in the example described above, when the storage apparatus 30 receives a confirmation request command comprising information on the GLDEV and the path to the LLDEV corresponding thereto from the edge storage 20, the storage apparatus 30 always sends the edge storage 20 information on the path of the LLDEV corresponding to the GLDEV included in the confirmation request command, and the edge storage 20 uses this path information to update the GLDEV/internal path translation table 2412, but the present invention is not limited thereto, and, for example, the storage apparatus 30 may determine whether or not the LLDEV path information in the confirmation request command is correct, and in a case where the LLDEV path information is correct, may send information to this effect to the edge storage 20, and in a case where the LLDEV path information is not correct, may send the edge storage 20 the correct LLDEV path information, and the edge storage 20 need do nothing in a case where the LLDEV path information is correct, and in a case where the LLDEV path information is not correct, may update the GLDEV/internal path translation table 2412 based on the LLDEV path information, which has been sent.

Also, in the example described above, the storage apparatus 30, upon receiving an IO request from the edge storage 20, notifies the edge storage 20 of the fact that LLDEV related to the IO request has been migrated, but the present invention is not limited thereto, and the storage apparatus 30 may notify the edge storage 20 of the fact that the LLDEV has been migrated at a time unrelated to the IO request from the edge storage 20. For example, in a case where the LLDEV has been migrated, the storage apparatus 30 may dynamically notify the edge storage 20 that the LLDEV was migrated. Also, in a case where LLDEV has been migrated, the storage apparatus 30 may dynamically send the edge storage 20 the path information of the post-migration LLDEV.

### REFERENCE SIGNS LIST

10 Host computer
20 Edge storage apparatus
30 Storage apparatus
40 Storage system
100 Data management system

1. A computer system, comprising:
one or more computers;
one or more storage systems comprising multiple storage apparatuses, which comprise one or more physical storage apparatuses and one or more logical storage apparatuses based on the one or more the physical storage apparatuses; and
one or more edge storage apparatuses, which are coupled corresponding to one of the computers between the computer and the storage system,
wherein a storage device of the edge storage apparatus stores identification information enabling the identification of a volume, which is provided to the computer and to which is allocated a storage area of the logical storage apparatus, and first access information for accessing the logical storage apparatus storing volume data of the volume in the storage system after associating identification information with first access information, wherein
a control device of the storage apparatus:
(A1) executes processing for transferring the volume data from a migration-source logical storage apparatus, which stores the volume data, to a migration-destination logical storage apparatus;
(A2) stores second access information for accessing the migration-destination logical storage apparatus in a storage device of the storage apparatus; and
(A3) sends the second access information to the edge storage apparatus, and wherein
a control device of the edge storage apparatus:
(B1) receives the second access information from the storage apparatus; and
(B2) associates the second access information with the identification information, which enables the identification of the volume, and stores the associated information in the storage device of the edge storage apparatus.

2. A computer system according to claim 1, wherein the control device of the storage apparatus executes the (A3) as the result of an input/output request from the edge storage apparatus.

3. A computer system according to claim 2, wherein the control device of the storage apparatus, in a case where the input/output request is for a logical storage apparatus which is the migration source of the volume data, (C1) sends to the edge storage apparatus a command issue instruction for issuing, as a response to the input/output request, an access information request command, which requests the second access information for accessing the logical storage apparatus, which is the migration destination of the volume data,
wherein the control device of the edge storage apparatus (D1) upon receiving the command issue instruction, issues to the storage apparatus an access information request command requesting the second access information for accessing the migration-destination the logical storage apparatus, and
wherein the control device of the storage apparatus (C2) executes the (A3) upon receiving the access information request command.

4. A computer system according to claim 3, wherein the control device of the storage apparatus:
associates notification information showing whether or not the second access information for accessing the migration-destination logical storage apparatus has been sent to the edge storage apparatus, which accessed the migration-source logical storage apparatus, with the first access information for accessing the migration-source logical storage apparatus, and stores the associated information in the storage device of the storage apparatus;
(E1) executes the (C1) in a case where the input/output request is for the volume data migration-source logical storage apparatus, and the notification information associated with the first access information for accessing the migration-source logical storage apparatus shows that the second access information has not been sent; and
(E2) executes the input/output processing to the logical storage apparatus corresponding to the input/output request in a case where the input/output request is not for a logical storage apparatus, which is the migration source of the volume data, or in a case where the input/output request is for a logical storage apparatus, which is the migration source of the volume data, and the notification information associated with the first access information for accessing the migration-source logical storage apparatus shows that the second access information has been sent.

5. A computer system according to claim 3, wherein the control device of the edge storage apparatus, in a case where the (C1) has been executed, sends, as an input/output request for the migration-destination logical storage apparatus, the input/output request corresponding to the response to the (C1).

6. A computer system according to claim 3, wherein
the storage device of the edge storage apparatus stores a corresponding relationship between an identification number, which makes it possible to identify the volume, and global identification information, which makes it possible to identify a global logical storage apparatus, which is uniquely managed by the storage system and is allocated to the volume, and, in addition, stores the global identification information and the first access information for accessing the logical storage apparatus of the storage apparatus, which is allocated to the global logical storage apparatus identified in accordance with the global identification information,
wherein the control device of the edge storage apparatus, in the (D1), adds the global identification information and the first access information to the access information request command, and sends this command to the storage apparatus,
wherein the storage device of the storage apparatus:
stores copy management information, which is associated with migration-source logical storage apparatus access information, global identification information of a global logical storage apparatus associated with the migration-source logical storage apparatus, migration-destination logical storage apparatus access information, and global identification information of a global logical storage apparatus associated with the migration-destination logical storage apparatus; and
stores access management information, which associates global identification information of a global logical storage apparatus, which is allocated to the logical storage apparatus accessible using the second access information, with the second access information, and
wherein the control device of the storage apparatus, in the (A3), in a case where second access information corresponding to the global identification information of the access information request command is stored in the access management information of the storage device of the storage apparatus, sends the relevant second access information, and in a case where second access information corresponding to the global identification information of the access information request command is not stored, uses the global identification information to search the copy management information, and in case where the global identification information is global identification information of a global logical storage apparatus associated with the migration-source logical storage apparatus, sends the access information of the migration-destination logical storage apparatus as the second access information, and in case where the global identification information is global identification information of a global logical storage apparatus associated with the migration-destination logical storage apparatus, sends the access information of the migration-source logical storage apparatus as the second access information.

7. A computer system according to claim 1, wherein the control device of the storage apparatus:
(F1) executes an initial copy process for thoroughly copying volume data of the migration-source logical storage apparatus to the migration-destination logical storage apparatus;
(F2) manages update information showing the presence or absence of an update for each storage area of a prescribed size in the migration-source logical storage apparatus during the processing of the initial copy process;
(F3) subsequent to the initial copy process, sends the update information to the storage apparatus storing the migration-destination logical storage apparatus;
(F4) executes the (A2) and the (A3) when the sending of the update information has been completed; and
(F5) based on the update information, reflects updated data of the migration-source logical storage apparatus in the migration-destination logical storage apparatus.

8. A computer system according to claim 7, wherein the control device of the storage apparatus, after the initial copy process has ended, instructs the edge storage apparatus to suspend the sending of an input/output request to the migration-source logical storage apparatus and the migration-destination logical storage apparatus until the (F3) is completed.

9. A computer system according to claim 7, wherein the control device of the storage apparatus, in a case where from the edge storage apparatus a write input/output request with respect to the migration-source logical storage apparatus and the migration-destination logical storage apparatus has been received after the initial copy process has ended, does not accept the input/output request, and issues an instruction to the edge storage apparatus to withhold the relevant input/output request.

10. A computer system according to claim 7, wherein the control device of a storage apparatus storing the migration-destination logical storage apparatus, after the (F5) has ended, executes a write process to the migration-destination logical storage apparatus corresponding to the post-initial copy process input/output request.

11. A data management method in accordance with a computer system, which comprises one or more computers, one or more storage systems comprising multiple storage apparatuses, which comprise one or more physical storage apparatuses and one or more logical storage apparatuses based on the one or more the physical storage apparatuses, and one or more edge storage apparatuses, which are coupled corresponding to one of the computers between the computer and the storage system,
wherein a storage device of the edge storage apparatus stores identification information enabling the identification of a volume, which is provided to the computer and to which is allocated a storage area of the logical storage apparatus, and first access information for accessing the logical storage apparatus storing volume data of the volume in the storage system after associating the identification information with first access information,
the data management method comprising:
(A1) executing a process for transferring the volume data from a migration-source logical storage apparatus, which stores the volume data, to a migration-destination logical storage apparatus;
(A2) storing a second access information for accessing the migration-destination logical storage apparatus in a storage device of the storage apparatus;
(A3) sending the second access information to the edge storage apparatus;
(B1) receiving the second access information from the storage apparatus; and
(B2) associating the second access information with the identification information, which enables the identification of the volume, and storing the associated information in the storage device of the edge storage apparatus.

12. A data management method according to claim 11, wherein the execution of the (A3) is the result of an input/output request from the edge storage apparatus.

13. A data management method according to claim 12, comprising, in a case where the input/output request is for a logical storage apparatus, which is the migration source of the volume data,
(C1) sending to the edge storage apparatus a command issue instruction for issuing, as a response to the input/output request, an access information request command requesting the second access information for accessing the logical storage apparatus, which is the migration destination of the volume data;
(D1) upon receiving the command issue instruction, issuing to the storage apparatus an access information request command requesting the second access information for accessing the migration-destination logical storage apparatus; and
(C2) executing the (A3) upon receiving the access information request command.

14. A data management method according to claim 13, comprising:
associating notification information showing whether or not the second access information for accessing the migration-destination logical storage apparatus has been sent to the edge storage apparatus, which accessed the migration-source logical storage apparatus, with the first access information for accessing the migration-source logical storage apparatus, and stores the associated information in the storage device of the storage apparatus;
(E1) executing the (C1) in a case where the input/output request is an input/output request for a logical storage apparatus, which is the migration source of the volume data, and the notification information associated with the first access information for accessing the migration-source logical storage apparatus shows that the second access information has not been sent; and
(E2) executing the input/output processing to the logical storage apparatus corresponding to the input/output request in a case where the input/output request is not for a logical storage apparatus, which is the migration source of the volume data, or in a case where the input/output request is for a logical storage apparatus, which is the migration source of the volume data, and the notification information associated with the first access information for accessing the migration-source logical storage apparatus shows that the second access information has been sent.

15. A data management method according to claim 13, comprising, in a case where the (C1) has been executed:
sending the input/output request corresponding to the response of the (C1) as an input/output request with respect to the migration-destination logical storage apparatus.
